(19) United States
(12) Patent Application Publication
(10) Pub. No.: US 2026/0228047 A1
(43) Pub. Date: Aug. 6, 2026

(54) AGENT ACTOR MANAGEMENT FRAMEWORK

(71) Applicant: Salesforce, Inc., San Francisco, CA (US)

(72) Inventors: Yacov Salomon, San Francisco, CA (US); Richard Perry Pack, III, San Francisco, CA (US); Kevin Xie, San Francisco, CA (US)

(21) Appl. No.: 19/042,403

(22) Filed: Jan. 31, 2025

(51) Int. Cl. G06F 9/50; G06F 9/54

(52) U.S. Cl. CPC G06F 9/5027; G06F 9/54

(57) ABSTRACT

The techniques described herein may include a framework for utilizing agent actors in a distributed manner. For example, an agent actor may be an autonomous digital agent that receives inputs and performs tasks based on the inputs and a dynamic behavioral state. The framework for may include an agent actor runtime (ART) system, which may include ART-brokers and ART-providers. ART-providers may include one or more servers or processors configured to provide computational resources for running one or more agent actors. ART-providers may register with an ART-broker by transmitting a request to register that indicates a provider domain, a provider address, or both, associated with the ART-provider. The ART-broker may include one or more servers or processors that provide computational resources for receiving, managing, and routing communications between users of the ART system and the registered ART-providers.

### FIELD OF TECHNOLOGY

The present disclosure relates generally to database systems and data processing, and more specifically to agent actor management framework.

### BACKGROUND

A cloud platform (i.e., a computing platform for cloud computing) may be employed by multiple users to store, manage, and process data using a shared network of remote servers. Users may develop applications on the cloud platform to handle the storage, management, and processing of data. In some cases, the cloud platform may utilize a multi-tenant database system. Users may access the cloud platform using various user devices (e.g., desktop computers, laptops, smartphones, tablets, or other computing systems, etc.).

In one example, the cloud platform may support customer relationship management (CRM) solutions. This may include support for sales, service, marketing, community, analytics, applications, and the Internet of Things. A user may utilize the cloud platform to help manage contacts of the user. For example, managing contacts of the user may include analyzing data, storing and preparing communications, and tracking opportunities and sales.

Some systems may provide models for building software tools, where the software tools may be user driven, stateless, and designed for a specific task. For example, such tools may include large language models (LLMs), machine learning (ML) models, or other software tools. Alternatively, an agent actor (e.g., an autonomous digital agent) may be a goal-oriented software process configured to determine actions to perform based on one or more of inputs (e.g., referred to as messages or commands), a state of the agent actor (e.g., a behavioral state), and other determined actions. For example, agent actors may proactively execute tasks (e.g., without direct instruction after an initial setup) and may seek assistance in executing the tasks via requesting user input, utilizing one or more tools (e.g., LLMs, ML models, software services, other agent actors), or both. In some cases, implementing agent actors at a user device may include increased processing power and memory usage at the user device compared to software tools. Additionally, implementing agent actors via a remote system may include complex coordination that may result in error propagation and decreased computational efficiencies.

### BRIEF DESCRIPTION OF THE DRAWINGS

FIG. 1 illustrates an example of a data processing system that supports agent actor management framework in accordance with aspects of the present disclosure.

FIG. 2 shows an example of an agent actor model that supports an agent actor management framework in accordance with aspects of the present disclosure.

FIG. 3 shows an example of a runtime system that supports an agent actor management framework in accordance with aspects of the present disclosure.

FIG. 4 shows an example of a runtime broker model that supports an agent actor management framework in accordance with aspects of the present disclosure.

FIGS. 5A and 5B show examples of runtime provider models that support an agent actor management framework in accordance with aspects of the present disclosure.

FIG. 6 shows a block diagram of an apparatus that supports agent actor management framework in accordance with aspects of the present disclosure.

FIG. 7 shows a block diagram of an agent actor manager that supports agent actor management framework in accordance with aspects of the present disclosure.

FIG. 8 shows a diagram of a system including a device that supports agent actor management framework in accordance with aspects of the present disclosure.

FIGS. 9 and 10 show flowcharts illustrating methods that support agent actor management framework in accordance with aspects of the present disclosure.

### DETAILED DESCRIPTION

Some systems may provide models for building software tools, where the software tools may be user driven, stateless, and designed for a specific task. For example, such tools may include large language models (LLMs), machine learning (ML) models, or other software tools. Alternatively, an agent actor (e.g., an autonomous digital agent) may be a goal-oriented software process configured to determine actions to perform based on one or more of inputs (e.g., referred to as messages or commands), a state of the agent actor (e.g., a behavioral state), and other performed actions. For example, agent actors may proactively execute tasks (e.g., without direct instruction after an initial setup) and may seek assistance in executing the tasks via requesting user input, utilizing one or more tools (e.g., LLMs, ML models, software services, other agent actors), or both. In some cases, implementing agent actors at a user device may include increased processing power and memory usage at the user device compared to implementing software tools. Additionally, a distributed system (e.g., a cloud system, a network including one or more remote servers or providers) for implementing agent actors for the user may lack coordination techniques (e.g., between remote servers or providers), and thus may increase fault propagation, reduce computational efficiency, and decrease scalability associated with using the agent actors.

The techniques described herein may include a framework (e.g., an agent actor system, architecture, model) for implementing agent actors in a distributed manner that is accessible to one or more users (e.g., or applications). For example, via the framework, a user may create (e.g., spawn), manage, and utilize agent actors for assisting in various activities, such as business related activities, software management activities, or others. In some cases, the framework for supporting the use of agent actors may include an agent actor runtime (ART) system for handling runtime execution of the agent actors. The ART system may include ART-brokers (e.g., also referred to as runtime brokers, a first service) and ART-providers (e.g., also referred to as runtime providers, a second service). In some cases, an ART-provider may run (e.g., host, implement, execute) the agent actors, or may include, support, or manage one or more servers or processors configured to provide computational resources (e.g., memory, power) for running one or more agent actors. The ART-providers may register with an ART-broker by transmitting a request to register that indicates a provider domain, a provider address, or both, associated with the ART-provider. The ART-broker may include one or more servers or processors that provide computational resources for receiving, managing, and routing communications between users of the ART system (e.g., users, applications) and the registered ART-providers. The ART-broker may also manage resource allocation between multiple registered ART-providers for hosting multiple agent actors.

Accordingly, a user (e.g., or an application) may create and utilize an agent actor via the ART system. For example, the ART-broker may receive a request from the user to spawn an agent actor, and the ART-broker may designate a registered ART-provider for spawning and providing resources to run the agent actor. The ART-provider may spawn the agent actor and support the agent actor with computational resources to accomplish tasks based on input (e.g., messages) routed from the user (e.g., or other applications) through the ART-broker to the ART-provider for the agent actor

In some cases, an ART-provider may provide resources for (e.g., may run) the agent actors via various techniques. In one example, the ART-provider may run the agent actors using a thread-mapping technique, where each agent actor may be associated with one or more threads of a processor of the ART-provider. In another example, the ART-provider may run the agent actors using a coordinated-workers-based technique. For example, the ART-provider may support (e.g., implement, run) one or more actor executors (e.g., workers), where an actor executor may load an agent actor persona of an agent actor and perform actions for the agent actor based on receiving inputs for the agent actor from a mailbox table associated with one or more agent actors.

The techniques described herein may provide one or more improvements to the functioning of a computer and improve the technical field of distributed agent actor implementation. For example, by providing a framework for utilizing agent actors in cloud based and distributed manner, a user device may conserve memory and power resources while utilizing agent actors for one or more tasks. Additionally, based on the coordination techniques between devices (e.g., ART-brokers, ART-providers, user devices) described herein, distributed servers or processors implementing the framework described herein may avoid errors in the distributed implementation of agent actors (e.g., such as errors relating to using invalid data or overwriting data that is not supposed to be overwritten). Additionally, the coordination techniques and framework described herein may increase computational efficiency of running agent actors in a distributed manner by providing techniques for running agent actors in parallel at an ART-provider (e.g., such as the thread-mapping technique or the coordinated-workers-based technique).

Aspects of the disclosure are initially described in the context of an environment supporting an on-demand database service. Aspects of the disclosure are also described in the context of agent actor models, runtime systems, runtime broker models, and runtime provider models. Aspects of the disclosure are further illustrated by and described with reference to apparatus diagrams, system diagrams, and flowcharts that relate to agent actor management framework.

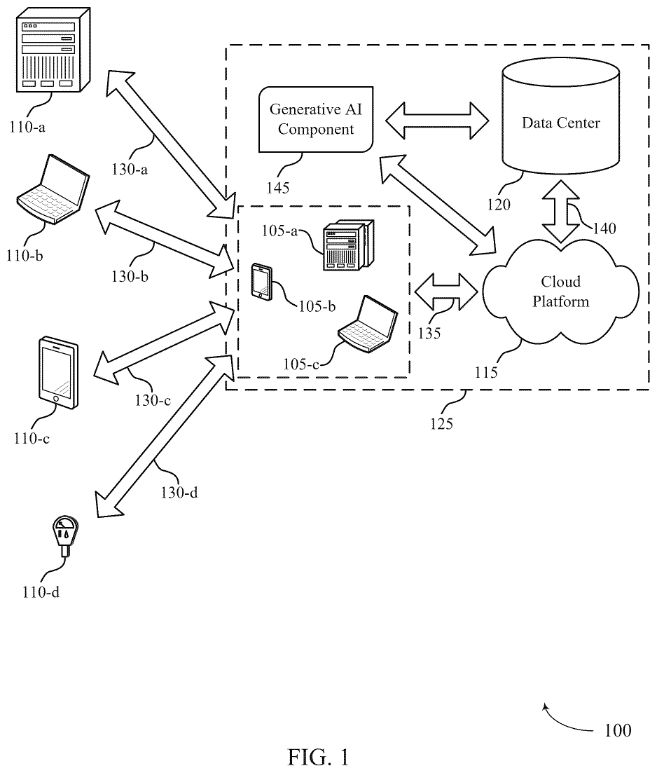

FIG. 1 illustrates an example of a system 100 for cloud computing that supports an agent actor management framework in accordance with various aspects of the present disclosure. The system 100 includes cloud clients 105, contacts 110, cloud platform 115, and data center 120. Cloud platform 115 may be an example of a public or private cloud network. A cloud client 105 may access cloud platform 115 over network connection 135. The network may implement transfer control protocol and internet protocol (TCP/IP), such as the Internet, or may implement other network protocols. A cloud client 105 may be an example of a user device, such as a server (e.g., cloud client 105-a), a smartphone (e.g., cloud client 105-b), or a laptop (e.g., cloud client 105-c). In other examples, a cloud client 105 may be a desktop computer, a tablet, a sensor, or another computing device or system capable of generating, analyzing, transmitting, or receiving communications. In some examples, a cloud client 105 may be operated by a user that is part of a business, an enterprise, a non-profit, a startup, or any other organization type.

A cloud client 105 may interact with multiple contacts 110. The interactions 130 may include communications, opportunities, purchases, sales, or any other interaction between a cloud client 105 and a contact 110. Data may be associated with the interactions 130. A cloud client 105 may access cloud platform 115 to store, manage, and process the data associated with the interactions 130. In some cases, the cloud client 105 may have an associated security or permission level. A cloud client 105 may have access to certain applications, data, and database information within cloud platform 115 based on the associated security or permission level and may not have access to others.

Contacts 110 may interact with the cloud client 105 in person or via phone, email, web, text messages, mail, or any other appropriate form of interaction (e.g., interactions 130-a, 130-b, 130-c, and 130-d). The interaction 130 may be a business-to-business (B2B) interaction or a business-to-consumer (B2C) interaction. A contact 110 may also be referred to as a customer, a potential customer, a lead, a client, or some other suitable terminology. In some cases, the contact 110 may be an example of a user device, such as a server (e.g., contact 110-a), a laptop (e.g., contact 110-b), a smartphone (e.g., contact 110-c), or a sensor (e.g., contact 110-d). In other cases, the contact 110 may be another computing system. In some cases, the contact 110 may be operated by a user or group of users. The user or group of users may be associated with a business, a manufacturer, or any other appropriate organization.

Cloud platform 115 may offer an on-demand database service to the cloud client 105. In some cases, cloud platform 115 may be an example of a multi-tenant database system. In this case, cloud platform 115 may serve multiple cloud clients 105 with a single instance of software. However, other types of systems may be implemented, including—but not limited to—client-server systems, mobile device systems, and mobile network systems. In some cases, cloud platform 115 may support CRM solutions. This may include support for sales, service, marketing, community, analytics, applications, and the Internet of Things. Cloud platform 115 may receive data associated with contact interactions 130 from the cloud client 105 over network connection 135, and may store and analyze the data. In some cases, cloud platform 115 may receive data directly from an interaction 130 between a contact 110 and the cloud client 105. In some cases, the cloud client 105 may develop applications to run on cloud platform 115. Cloud platform 115 may be implemented using remote servers. In some cases, the remote servers may be located at one or more data centers 120.

Data center 120 may include multiple servers. The multiple servers may be used for data storage, management, and processing. Data center 120 may receive data from cloud platform 115 via connection 140, or directly from the cloud client 105 or an interaction 130 between a contact 110 and the cloud client 105. Data center 120 may utilize multiple redundancies for security purposes. In some cases, the data stored at data center 120 may be backed up by copies of the data at a different data center (not pictured).

Subsystem 125 may include cloud clients 105, cloud platform 115, and data center 120. In some cases, data processing may occur at any of the components of subsystem 125, or at a combination of these components. In some cases, servers may perform the data processing. The servers may be a cloud client 105 or located at data center 120.

The system 100 may be an example of a multi-tenant system. For example, the system 100 may store data and provide applications, solutions, or any other functionality for multiple tenants concurrently. A tenant may be an example of a group of users (e.g., an organization) associated with a same tenant identifier (ID) who share access, privileges, or both for the system 100. The system 100 may effectively separate data and processes for a first tenant from data and processes for other tenants using a system architecture, logic, or both that support secure multi-tenancy. In some examples, the system 100 may include or be an example of a multi-tenant database system. A multi-tenant database system may store data for different tenants in a single database or a single set of databases. For example, the multi-tenant database system may store data for multiple tenants within a single table (e.g., in different rows) of a database. To support multi-tenant security, the multi-tenant database system may prohibit (e.g., restrict) a first tenant from accessing, viewing, or interacting in any way with data or rows associated with a different tenant. As such, tenant data for the first tenant may be isolated (e.g., logically isolated) from tenant data for a second tenant, and the tenant data for the first tenant may be invisible (or otherwise transparent) to the second tenant. The multi-tenant database system may additionally use encryption techniques to further protect tenant-specific data from unauthorized access (e.g., by another tenant).

Additionally, or alternatively, the multi-tenant system may support multi-tenancy for software applications and infrastructure. In some cases, the multi-tenant system may maintain a single instance of a software application and architecture supporting the software application in order to serve multiple different tenants (e.g., organizations, customers). For example, multiple tenants may share the same software application, the same underlying architecture, the same resources (e.g., compute resources, memory resources), the same database, the same servers or cloud-based resources, or any combination thereof. For example, the system 100 may run a single instance of software on a processing device (e.g., a server, server cluster, virtual machine) to serve multiple tenants. Such a multi-tenant system may provide for efficient integrations (e.g., using application programming interfaces (APIs)) by applying the integrations to the same software application and underlying architectures supporting multiple tenants. In some cases, processing resources, memory resources, or both may be shared by multiple tenants.

As described herein, the system 100 may support any configuration for providing multi-tenant functionality. For example, the system 100 may organize resources (e.g., processing resources, memory resources) to support tenant isolation (e.g., tenant-specific resources), tenant isolation within a shared resource (e.g., within a single instance of a resource), tenant-specific resources in a resource group, tenant-specific resource groups corresponding to a same subscription, tenant-specific subscriptions, or any combination thereof. The system 100 may support scaling of tenants within the multi-tenant system, for example, using scale triggers, automatic scaling procedures, scaling requests, or any combination thereof. In some cases, the system 100 may implement one or more scaling rules to enable relatively fair sharing of resources across tenants. For example, a tenant may have a threshold quantity of processing resources, memory resources, or both to use, which in some cases may be tied to a subscription by the tenant.

In some examples, the system 100 may include a generative artificial intelligence (AI) component 145. The generative AI component 145 may be an example or a component of a large language model (LLM), such as a generative AI model. In some examples, the generative AI component 145 may additionally, or alternatively, be referred to as any of an AI, a generative AI (GAI), a GAI model, an LLM, a machine learning model, or any similar terminology. The generative AI component 145 may be a model that is trained on a corpus of input data, which may include text, images, video, audio, structured data, or any combination thereof. Such data may represent general-purpose data, domain-specific data, or any combination thereof. Further, the generative AI component 145 may be supplemented with additional training on data associated with a role, function, or generation outcome to further specialize the generative AI component 145 and increase the accuracy and relevance of information generated with the generative AI component 145.

In some examples, the cloud platform 115 may receive a query from a cloud client 105 that may include a request to produce a response (e.g., text, images, video, audio, or other information) to the query using the generative AI component 145. The cloud platform 115 may input a prompt to the generative AI component 145 that includes, or otherwise indicates, the query (or information included therein). The generative AI component 145 may generate an output (e.g., text, images, video, audio, or other information) that is responsive to the prompt. In some examples, the cloud platform 115 may modify or supplement one or more aspects of the query to increase the quality of the response. In some examples, such modification or supplementation may be referred to as grounding.

The system 100 may support any configuration for the use of generative AI models. In FIG. 1, the generative AI component 145 is depicted as being located external to the subsystem 125. However, the generative AI component 145 may be hosted on the cloud platform 115, elsewhere within the subsystem 125, or outside the subsystem 125 (e.g., a publicly-hosted platform). Additionally, or alternatively, multiple generative AI components 145 may be employed to perform one or more of the actions described as being performed by a single generative AI component 145. Further, in some examples, the generative AI component 145 may communicate with one or more other elements, such as a contact 110, the data center 120, one or more other elements, or any combination thereof, to receive additional information (e.g., that may be indicated in the query or the prompt) that is to be considered for performing generative processes.

In various implementations, the models and/or modules described herein (e.g., including, but not limited to, the generative AI component 145) may be classification, predictive, generative, conversational, or another form of AI technology, such as AI model(s), agents, etc., implementing one or more forms of machine learning, a neural network, statistical modeling, deep learning, automation, natural language processing, or other similar technology. The AI technology may be included as part of a network or system comprising a hardware- or software-based framework for training, processing, fine-tuning, or performing any other implementation steps. Furthermore, the AI technology may include a hardware- or software-based framework that performs one or more functions, such as retrieving, generating, accessing, transmitting, etc. The AI technology may be implemented by a computer including a register coupled with a processor or a central processing unit (CPU).

Moreover, the AI technology may be trained or fine-tuned using supervised, unsupervised, or other AI training techniques. In various implementations, the AI technology may be trained or fine-tuned using a set of general datasets or a set of datasets directed to a particular field or task. Additionally, or alternatively, the AI technology may be intermittently updated at a set interval or in real time based on resulting output or additional data to further train the AI technology. The AI technology may offer a variety of capabilities including text, audio, image, and other content generation, translation, summarization, classification, prediction, recommendation, time-series forecasting, searching, matching, pairing, and more. These capabilities may be provided in the form of output produced by the AI technology in response to a particular prompt or other input. Furthermore, the AI technology may implement Retrieval-Augmented Generation (RAG) or other techniques after training or fine-tuning by accessing a set of documents or knowledge base directed to a particular field or website other than the training or fine-tuning data to influence the AI technology's output with the set of documents or knowledge base.

To further guide and train output of the AI technology, one or more input prompts may be provided to the AI technology for the purpose of eliciting particular responses. In various implementations, the input prompts may correspond to the particular field or task to which the AI technology is trained. Additionally, or alternatively, the AI technology may be implemented along with one or more additional AI technologies. For example, a first AI model may produce a first output, which is used as input for a second AI model to produce a second output. These AI technologies may be used in succession of one another, in parallel with another, or a combination of both. Furthermore, the AI technologies may be merged in a variety of implementations, for example, by bagging, boosting, stacking, etc. the AI technologies.

Some systems may provide models for building software tools, where the software tools may be user driven, stateless, and designed for a specific task. For example, such tools may be associated with the generative AI component 145, or other software tools. Alternatively, an agent actor (e.g., an autonomous digital agent) may be a goal-oriented software process configured to determine actions to perform based on one or more of inputs (e.g., referred to as messages or commands), a state of the agent actor (e.g., a behavioral state), and other performed actions. For example, agent actors may proactively execute tasks (e.g., without direct instruction after an initial setup) and may seek assistance in executing the tasks via requesting user input, utilizing one or more tools (e.g., LLMs, ML models, software services, other agent actors), or both. In some cases, implementing agent actors at a user device (e.g., such as a cloud client 105) may include increased processing power and memory usage at the user device compared to implementing software tools. Additionally, a distributed system (e.g., the cloud platform 115, the data center 120, the subsystem 125, a network including one or more remote servers or providers) for implementing agent actors for the user may lack coordination techniques (e.g., between remote servers or providers), and thus may increase fault propagation in a distributed system, reduce computational efficiency of the distributed system, and decrease scalability associated with using the agent actors.

The techniques described herein include a framework (e.g., an agent actor system, architecture, model) for implementing agent actors in a distributed manner that is accessible to one or more users (e.g., or applications, such as cloud clients 105 or contacts 110). For example, via the framework, a user may spawn (e.g., create), manage, and utilize agent actors for assisting in various activities, such as business related activities, software management activities, or others. In some cases, the framework for supporting the use of agent actors may include an ART system for handling runtime execution of the agent actors. The ART system may include ART-brokers (e.g., also referred to as runtime brokers, a first service, one or more servers such as cloud client 105-a) and ART-providers (e.g., also referred to as runtime providers, a second service, one or more servers such as cloud client 105-a). In some cases, an ART-provider may run (e.g., host, implement, execute) the agent actors, or may include one or more servers or processors configured to provide computational resources (e.g., memory, power) for running one or more agent actors. The ART-providers may register with an ART-broker by transmitting a request to register that indicates a provider domain, a provider address, or both, associated with the ART-provider. The ART-broker may include one or more servers or processors that provide computational resources for receiving, managing, and routing communications between users of the ART system (e.g., users, applications) and the registered ART-providers. The ART-broker may also manage resource allocation between multiple registered ART-providers for hosting multiple agent actors.

In one example, a user may use an agent actor to monitor and process communications received via a group communication platform (e.g., Slack, email). The user may cause a request to be sent to an ART-broker (e.g., a first remote server) to spawn an agent actor to monitor and process the communications. After one or more ART-providers (e.g., second remote servers) have registered with the ART broker, the ART-broker may select an ART-provider to run the agent actor requested by the user, and may provide an identifier for the agent actor to the ART-provider. The ART-provider may spawn the agent actor, and may receive one or more messages (e.g., input) from the ART-broker associated with the agent actor. For example, the one or more messages may indicate information associated with the communications of the group-based communication platform. In some cases, an application associated with the user may generate the messages based on the communication, and may transmit the messages to the ART-broker. The ART-broker may forward the messages to the ART-provider to be routed to the agent actor. The ART-provider may cause the agent actor to perform (e.g., one or more processors of the ART-provider may perform) one or more tasks based on the messages, a behavioral state of the agent actor, and one or more behaviors of the agent actor. As one example, the one or more tasks may include using an LLM to generate an out of office response to an incoming message of the group communication platform. As another example, the one or more tasks may include spawning a second agent actor (e.g., via the ART-broker) to generate a report, and the agent actor may respond to an incoming message with the generated report. Additionally, or alternatively, the one or more tasks may include updating a behavioral state of the agent actor. Eventually, the user may no longer desire that the agent actor monitor and process the communications. Accordingly, the user may transmit, to the ART-broker, a request to delete of the agent actor. The ART-broker may post the request to delete the agent actor to the ART-provider, which may delete the agent actor. Thus, the user may utilize agent actors with reduced processing and memory usage at a user device, and one or more remote servers (e.g., the ART-broker, the ART-provider) may support agent actors with reduced errors, increased computational efficiency, and increased scalability.

It should be appreciated by a person skilled in the art that one or more aspects of the disclosure may be implemented in a system 100 to additionally, or alternatively, solve other problems than those described above. Furthermore, aspects of the disclosure may provide technical improvements to “conventional” systems or processes as described herein. However, the description and appended drawings only include example technical improvements resulting from implementing aspects of the disclosure, and accordingly do not represent all of the technical improvements provided within the scope of the claims.

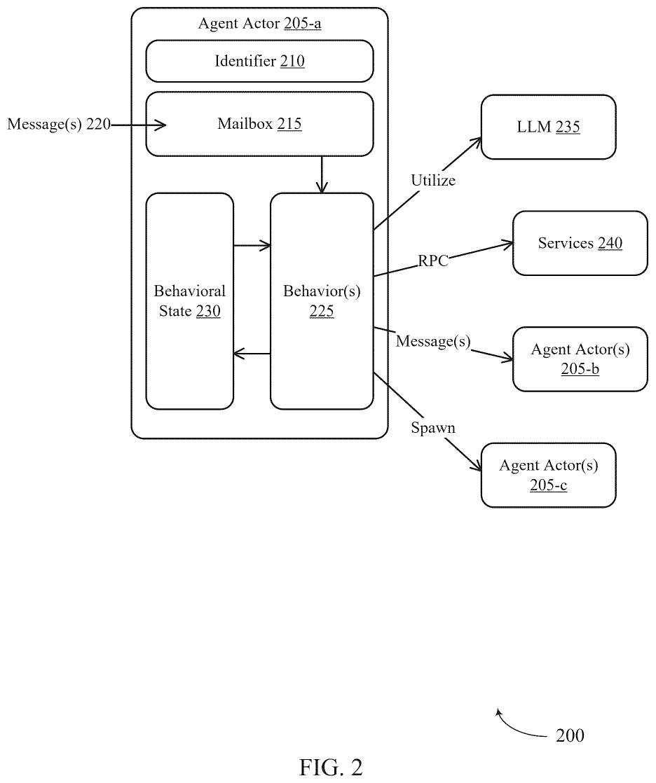

FIG. 2 shows an example of an agent actor model 200 that supports an agent actor management framework in accordance with aspects of the present disclosure. In some cases, aspects of the agent actor model 200 may implement or be implemented by aspects of FIG. 1. For example, the agent actor model 200 may be supported or implemented on or through a remote server or ART-provider, which may include one or more of the components of the system 100. For example, the agent actor model 200 may be implemented on or by one or more of the contacts 110, the cloud clients 105, the cloud platform 115, the data center 120, or any other component of the subsystem 125. In some cases, the agent actor model 200 may illustrate conceptual definitions and one or more characteristics of an agent actor 205 to be used in the ART system.

In some aspects, advancements in LLM capabilities have increased the utility of AI in the software industry. For example, based on a prompt, some LLMs may generate a response (e.g., an original response, may “think,” “reason,” or provide a “thought”) by generating one token at a time based on a training of the LLM. Such capabilities may enable users to create agent actors 205 (e.g., collaborative digital agents) to perform, assist in performance of, or augment performance of tasks based on an agent actor persona of the agent actor and messages for the agent actor (e.g., inputs).

Agent actors 205 may be significantly different from other tools, including digital or software tools. A summary of some of the differences between tools and agent actors 205 is provided in Table 1.

TABLE 1

| | Tools | Agent Actors |
|---|---|---|
| Usage | Specific | Goal-oriented |
| Operation | User-driven | Autonomous |
| Life Cycle | Predictable; Short-lived | Dynamic; finite |
| Interaction | One-way; Request/Response | Bi-directional; |
| Pattern | | Asynchronous |
| Access | Private; Isolated | Collaborative |
| State | Stateless | Stateful |

In some examples, tools may have specific functionality, and may be user-driven. For example, a user may call upon a tool, but tools may not act independently and may receive direct user input or instructions to operate. In some cases, a user may decide when and how a tool is used. Alternatively, an agent actors 205 may operate entirely or partly autonomously. For example, an agent actor may perform one or more actions or tasks “on their own” based on received messages (e.g., indicating situational informal, context, or other information) and a persona (e.g., a behavioral state 230, behaviors 225, and accepted messages) of the agent actor 205. Additionally, agent actors 205 may be goal-oriented, and may determine or adjust actions to perform based on changing conditions or feedback with respect to a corresponding goal (e.g., indicated by one or more messages 220 to the agent actor 205).

Unlike tools, agent actors 205 may act proactively, such as by executing tasks without direct instruction after an initial setup, and may also seek help via user input or utilizing tools in response to new input or changing conditions. For example, an agent actor 205 may utilize an LLM 235 or other ML models, communicate with other services 240 (e.g., via a remote procedure call (RPC)), communicate message(s) with other agent actors (e.g., such as agent actors 205-b), may spawn other agent actors to help with tasks (e.g., such as agent actors 205-c), or any combination thereof.

Additionally, a user may interact differently with tools and agent actors. For example, a user may generally use tools for specific (e.g., one-off) tasks in short, focused sessions. In some cases, each use of a tool may be isolated and disparate from other uses of the tool, and each use of the tool may not affect or be affected by other uses of the tool. In contrast, user interaction with agent actors may include bi-directional communication, which may allow an agent actor to work with multiple users and other digital agents simultaneously, and respond appropriately based on a respective behavioral state of the agent actor at any time, where the behavioral state may be based on past user interactions or uses. Additionally, agents actors may proactively send messages to a user or other tools to assist in performing tasks without being explicitly prompted to send a message.

Some software models and architectures allow users to build various tools. However, such software models may not adequately support developers in creating agent actors 205 (e.g., or autonomous digital agents). For example, in building web services and applications, a user may rely on RPC-like request and response patterns to use tools, where each request may be handled by an isolated process or thread with limited knowledge of other processes or requests. While these patterns may suit tool usage, they may hinder developing, support, and running agent actors 205. For example, to enable agent actor use in some systems that support software tools, a user (e.g., a software engineer, a developer) may implement complex logic in an application layer with locks and synchronization techniques, which may divert the focus of the user from the specific behaviors of the agent actor 205 and decrease performance.

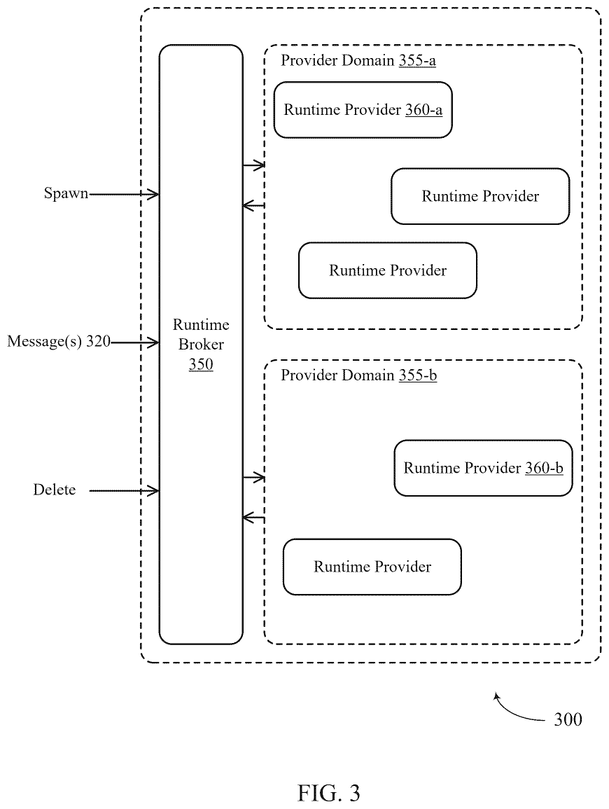

In some aspects, the techniques described herein may introduce a new computational model referred to as an agent actor model 200, which may assist developers in building and using agent actors 205. In some cases, web-service architectures may focus on using functions and tools as fundamental building blocks. In a similar manner, the agent actor model 200 may serve as a component for an ART system (e.g., such as a runtime system 300, as described with respect to FIG. 3). For example, using the agent actor model 200 and the ART system, a user may define an agent actor persona (e.g., as described herein) for an agent actor 205-a and may spawn the agent actor 205-a (e.g., one or more instances of the agent actor 205-a) in the ART system. One or more components of the ART system (e.g., a runtime provider, as described with respect to FIGS. 3-5B) may host and operate the agent actor 205-a. In some cases, the ART system may ensure that one or more characteristics of the agent actor 205-a are maintained, and may be implemented in an open, distributed, and resilient manner, as to allow access to agent actor 205-a with reduced errors and improved computational efficiency.

A computational model, such as the agent actor model 200 or one or more other models described herein, may involve design time aspects and a runtime aspects. Design time aspects may include a set of logical operations that may be triggered by specific events. Runtime aspects may specify how such logical operations may execute once defined, and may outline one or more properties that the ART system (e.g., a runtime system, as described with respect to FIG. 3) may maintain.

In the agent actor model 200, a user (e.g., an agent developer) may define a persona of the agent actor 205, referred to as an agent actor persona. An agent actor persona may indicate one or more accepted messages (e.g., input for the agent actor) and one or more behavior(s) 225 (e.g., output, actions, tasks) associated with the accepted messages. For example, the behavior(s) 225 may include logic or directions for handling messages 220 of different types and including different content.

In some cases, the one or more accepted messages may specify what type(s) of message(s) 220 can be sent to the agent actor 205. For example, the agent actor persona may indicate a set of data types that the agent actor 205 may process. Each message 220 may indicate information implicitly (e.g., context) and implicitly (e.g., content), where the data type may implicitly indicate information. For example, an agent actor may receive, from a user (e.g., via an ART-provider), a message 220 (e.g., a command) of a type referred to as “terminate,” which may implicitly or explicitly shut down operations of the agent actor 205. Alternatively, the agent actor 205 may receive a message including content of free-form text along with associated metadata which may be of a type referred to as “SupervisorMessage.” For example, the “SupervisorMessage” type may indicate context (e.g., that a message 220 from a user with a supervisor role is received), and the “content” field may include a field with a string of data. In some cases, the content of a message may include various kinds of information, including basic data types (e.g., integers, Booleans, strings, characters), document types (e.g., text files, portable document format (PDF) files, image files), emails or other messaging formats, or any combination thereof.

The behavior(s) 225 of the agent actor persona may define how the agent actor 205 may act when processing the accepted messages 220. That is, the agent actor 205-a may apply messages 220 to the behaviors 225 to perform tasks. For example, the behaviors 225 may define processing logic to be executed when an accepted message is ready to be processed, where the processing logic may be affected by (e.g., include reference to, be based on) a behavioral state 230 of the agent actor 205-a. For example, if the agent actor 205-a receives message 220 of a type “SupervisorMessage,” a behavior 225 may cause the agent actor 205-a to reply immediately if the behavioral state 230 is “Not Busy,” and the behavior 225 may case the agent actor 205-a to ignore the “SupervisorMessage” or respond with a confirmation or indication of a delayed response message if the behavioral state 230 is “Busy.” Additionally, or alternatively, a behavior 225 in response to a message 220 may affect (e.g., change) the set of accepted messages at the agent actor 205.

In some cases, completion of a task based on the behavior 225 and the messages 220 at an agent actor 205 may cause side effects. For example, the side effects may be that the task is complete, or a change in the behavioral state 230 of the agent actor 205. In some cases, the side effects may affect the behavior(s) 225 of the agent actor 205. That is, performing a first task in response to a first message 220 may cause the agent actor 205 to change its behavior 225 for processing future messages 220. As one exemplary explanation, let M be a set of accepted messages for the agent actor 205-a, and let E be a set of the side effects. The agent actor persona may be formally defined as a function ƒ(M) shown in Equation 1.

$$f ( M ) : M \to {f}^{′} ( M ) , E \qquad Eq . 1$$

After a user defines an agent actor persona for an agent actor 205, the user may transmit one or more requests to an ART-broker of the ART system to spawn instances of the agent actor 205. Accordingly, an ART-provider may spawn instances of the agent actor 205 and route messages 220 (e.g., accepted messages) to the agent actors 205. In some cases, a sender of the messages 220 may not know explicitly when the receiving agent actor 205 will process them, which may be similar to communicating to a human agent (e.g., via email or slack), where a sender may be unaware if the human agent is actively working on a received message. In some cases, an agent actor 205 may transmit a confirmation to a sender of the messages 220 through an explicit reply, or implicitly through observable side effects (e.g., completion of a requested task), or both.

In some cases, each agent actor 205 may maintain one or more properties during runtime, which may include identity integrity, unblocked messaging, and serialized processing. In some cases, the identity integrity property may be that all agent actors 205 (e.g., agent actor instances) within a set have an identifier 210 that is unique. Such identifiers 210 may be linked to the current behavioral states 230 of a respective agent actor 205, and allow for messages 220 to be routed to the correct agent actor 205. In some cases, the identifier 210 of an agent actor 205 may be determined by an application or user requesting to spawn the agent actor or the ART-broker that receives the request to spawn the agent actor 205. The unblocked messaging property may be that any message sent to an agent actor 205 with a specified identifier 210 will be delivered to the agent actor 205 with the identifier 210. For example, the sender of the message 220 may not be blocked by processing of other messages 220. The serialized processing property may indicate when and how the message 220 are processed by the agent actors 205. For example, the serialized processing property may be that messages 220 are processed at an agent actor 205 by the associated behavior 225 one at a time (e.g., serially). For example, the messages 220 may be processed in an order of receipt (e.g., chronologically).

These properties may establish expectations that a user may have of an agent actor 205. For example, the identity integrity property may maintain that a user is interacting with an intended agent actor 205 instead another agent actor 205. The unblocked messaging property may maintain that a message from a user is delivered to the correct agent actor 205. The serialized processing property may maintain that a message from the user is processed by the agent actor 205 based on the behavioral state 230 and behaviors 225 of the agent actor 205. Such properties may assist agent actors 205 in collaborating with multiple parties while maintain internal consistency. For example, such properties may allow a user to communicate with an agent actor 205 that is responsible for a specified goal and is aware of up-to-date information associated with the goal.

Another aspect of the agent actor model 200 is that agent actors 205 may have dynamic, finite life cycles. By contrast, services 240 may have no defined starting or ending point (e.g., similar to LLMs 235). However, an agent actor 205 may be spawned (e.g., initiated) in response to defining or identifying a goal or task, assigned to that goal or task, and deleted (e.g., terminated) in response to accomplishing the goal or task.

In some cases, a system for running agent actors 205 (e.g., such as an ART system, a runtime system 300) may operate as an orchestrator of a collection of agent actors 205 (e.g., or agent actor containers). For example, each agent actor 205 may be referred to as an agent actor container that includes components to effectuate the key properties of an agent actors 205. For example, the agent actor 205 may include an identifier 210 to achieve the identity integrity property, a mailbox 215 to achieve the unblocked messaging property, and the behaviors 225 and behavioral state 230 to achieve the serialized processing property.

In some cases, the identifier 210 may indicate a unique identifier associated with the agent actor 205-a. For example, the system that runs the agent actors 205 may use the identifier 210 to deliver and route each message 220 to the agent actor 205-a. The identifier 210 may enable the system to implement the identity integrity property described herein.

In some cases, the mailbox 215 may receive and store the messages 220 received at the agent actor 205-a. For example, if a message 220 is routed to the agent actor 205-a, the message 220 is appended to the mailbox 215 and is ready to be processed by an associated behavior 225 based on an order of receipt with respect to other messages 220. The mailbox 215 may implement the unblocked messaging property described herein.

In some cases, the behavioral state 230 and behaviors 225 may include the behavior logic and associated state of the agent actor 205-a (e.g., as included in the current behavior function in Equation 1). For example, the agent actor 205-a may continuously (e.g., while messages 220 are in the mailbox 215) pull a message 220 from the mailbox 215, apply the message 220 to corresponding behaviors 225 (e.g., by perform one or more actions or tasks) based on a context and content of the message 220, update the behavioral state 230 in response to applying the message 220 to the corresponding behavior 225, and repeat (e.g., until the mailbox 215 is empty).

In some cases, the agent actor model 200 may allow a user device to utilize agent actors 205 via a distributed system, which may utilize fewer power and memory resources at the user device. The agent actor model 200 may also allow a distributed system to implement agent actors 205 with reduced error propagation, increased computational efficiency, and increased scalability.

FIG. 3 shows an example of a runtime system 300 (e.g., such as the ART system described herein with respect to FIGS. 1 and 2) that supports an agent actor management framework in accordance with aspects of the present disclosure. In some cases, aspects of the runtime system 300 may implement or be implemented by aspects of FIGS. 1 and 2. For example, the runtime system 300 may include one or more runtime providers 360 (e.g., ART providers as described herein with respect to FIGS. 1 and 2, a runtime provider 360-a, a runtime provider 360-b), where each runtime provider 360 may provide and manage resources for implementing one or more agent actors (e.g., such as the agent actors 205) according to the agent actor model 200 of FIG. 2. In some aspects, the runtime system 300 may include a runtime broker 350 that interfaces with the one or more runtime providers 360 to provide messages 320 to the runtime providers 360 for the one or more agent actors (e.g., such as agent actors 205).

In some aspects, the runtime system 300 (e.g., an ART system) may manage a life cycle, processing, and message routing for a collection of agent actors 205 (e.g., agent actor containers) hosted by the runtime providers 360 (e.g., the runtime providers 360). In some other systems (e.g., single computer systems), the agent actor model 200 may manage the life cycle of the agent actors 205. Additionally, or alternatively, the runtime system 300 may handle communication across multiple concurrent computers, servers, processors, or systems, and may coordinate between the computers, servers, processors, or systems to ensure fault tolerance associated with the agent actors 205, scalability for the runtime system 300, and extensibility.

In some aspects, the runtime system 300 may include a runtime broker 350 (e.g., an ART-Broker, a first type of service) and one or more runtime providers 360 (e.g., one or more ART-Providers, a second type of service). Each of the runtime broker 350 and runtime providers 360 may be performed on one or more computers, servers, or processors that may be collocated or distributed, such as in a cloud-based system. In some cases, each runtime provider 360 may include a service that hosts, manages, and provides computational, memory, and power resources required to run one or more agent actors (e.g., agent actors 205). The runtime providers 360 may run and maintain the state of each agent actor according to the defined agent actor persona, as described with respect to FIG. 2.

Additionally, each runtime provider 360 may belong to (e.g., be associated with, identify with, correspond to) a provider domain 355. For example, the runtime provider 360-a may belong to a provider domain 355-a, and the runtime provider 360-b may belong to the provider domain 355-b. In some cases, the runtime system 300 may maintain the identity integrity property described with respect to FIG. 2 across the runtime providers 360 within a provider domain 355, such that only one runtime provider 360 in a provider domain 355 may manage an agent actor associated with a same identifier. That is, an agent actor identifier may be unique within a provider domain 355-a, but may be reused across provider domains 355. In some cases, a provider domain 355 may include runtime providers 360 within a geographical area, runtime providers 360 associated with a set of capabilities, runtime providers 360 that may share another commonality, runtime providers 360 that selected the provider domain, or any combination thereof.

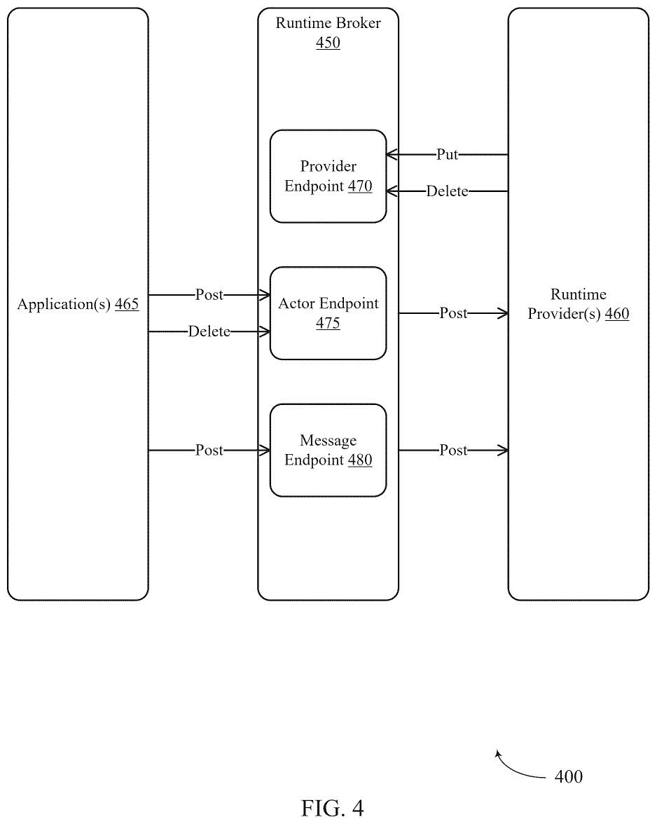

In some cases, the runtime broker 350 may not provide resources to directly implement (e.g., may not run) one or more agent actors. Instead, the runtime broker 350 may maintain a list (e.g., a registry) of runtime providers 360, agent actors, or both, where the list may be intended for exposure outside the runtime providers 360. That is, users, applications, or other entities may interface with the runtime broker to interact with agent actors implemented (e.g., hosted) by the runtime providers 360. As the list may indicate which runtime provider 360 hosts which agent actor, the runtime broker 350 may also route messages 320 to the correct runtime providers 360 based on a provider domain 355 and agent actor identifier indicated by the messages 320. The runtime broker may also receive requests to spawn and delete agent actors, which may be further described with respect to FIG. 4.

In some cases, a runtime system 300 may allow for a distributed or cloud based system of operating and utilizing agent actors, which may reduce resource draw at a user device. Additionally, the techniques of the runtime system 300 described herein may reduce error propagation and increase computational efficiency in implementing the agent actors in a distributed manner.

FIG. 4 shows an example of a runtime broker model 400 that supports an agent actor management framework in accordance with aspects of the present disclosure. In some cases, aspects of the runtime broker model 400 may implement or be implemented by aspects of FIGS. 1-3. For example, the runtime broker model 400 may illustrate one or more functions of a runtime broker 450, which may be an example of an ART-broker, as described with respect to FIGS. 1 and 2, and the runtime broker 350, as described herein with respect to FIG. 3. In some aspects, the runtime broker 450 may include one or more endpoints for interfacing with applications 465 (e.g., or users) and runtime providers 460 (e.g., examples of the runtime providers 360 as described with respect to FIG. 3 and the ART-providers as described with respect to FIGS. 1 and 2). In some cases used herein, the applications 465 may be interchangeable with users (e.g., or a user device).

In some cases, the runtime broker 450 may be a service (e.g., an always-running service, constantly powered) that may route messages from a sender (e.g., the applications 465, a user) to an appropriate runtime provider 460 (e.g., ART-Provider). Additionally, the runtime broker 450 may receive requests (e.g., calls, commands) from the applications 465 to spawn, delete, and message agent actors. In some cases, the runtime broker 450 may also receive requests (e.g., calls, commands) from the runtime providers 460 to register with the runtime broker 450 or deregister with the runtime broker 450 (e.g., to join or leave an ART system).

To receive and output such requests, the runtime broker 450 may include one or more endpoints. In some cases, the runtime broker 450 may include a provider endpoint 470. In some cases, the runtime broker 450 may use the provider endpoint 470 when runtime providers 460 join or leave the runtime system. For example, at the provider endpoint 470, the runtime broker 450 may receive requests to register (e.g., put calls) and deregister (delete calls) from runtime providers 460. For example, registering at a runtime broker 450 may add the runtime provider 460 to a list maintained at the runtime broker 450 (e.g., as described with respect to FIG. 3), and deregistering at the runtime broker 450 may remove the runtime provider 460 from the list (e.g., as described with respect to FIG. 3). In some cases, a request to register a runtime provider 460 may indicate a provider domain (e.g., such as the provider domain 355 as described with respect to FIG. 3) associated with the runtime provider 460, a reachable address associated with the runtime provider 460, or both. The runtime broker 450 may use the information indicated in the put call as a unique key for identification of the runtime provider 460, for example, for forwarding future commands or messages. In some cases, a request to deregister a runtime provider 460 may also indicate the provider domain, the reachable address, or both, associated with a runtime provider 460, along with a request to be deregistered (e.g., delisted, deleted).

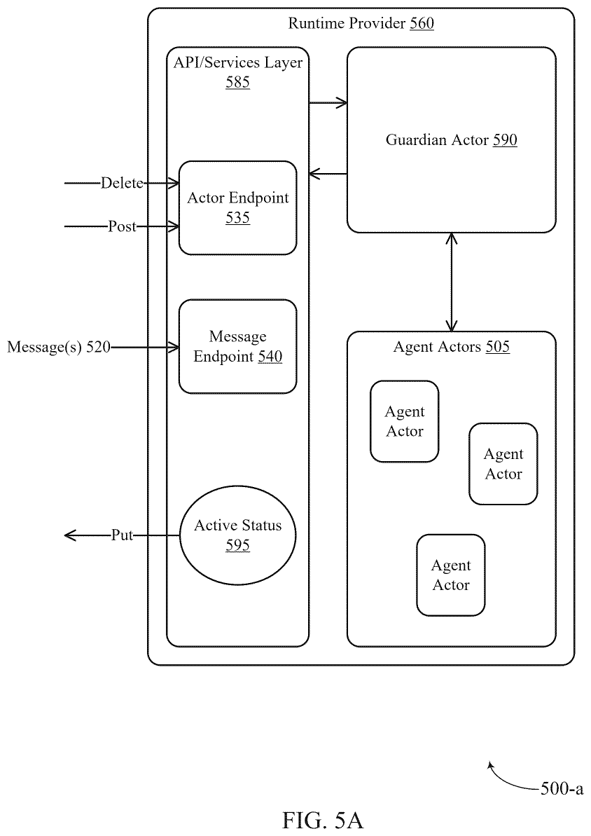

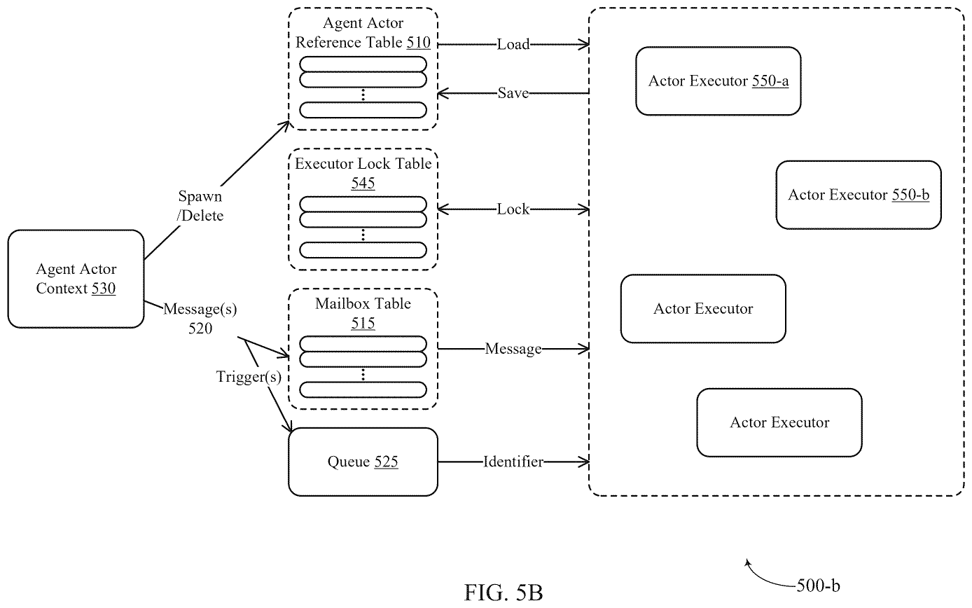

In some cases, runtime providers 460 may also periodically (e.g., continuously, upon request, at a regular interval) send indications of an active status (e.g., put calls) to the provider endpoint 470. Such indications may indicate an availability or ability of the runtime provider 460 to host agent actors (e.g., as further described with respect to FIGS. 5A and 5B). For example, if the runtime broker 450 does not receive the indication of the active status from a runtime provider 460 within one or more regular intervals (e.g., within a specified timeout period), the runtime broker 450 may deregister the runtime provider 460.

The runtime broker 450 may also include an actor endpoint 475. For example, the actor endpoint 475 may facilitate applications 465 spawning (e.g., creating) and deleting agent actors to be hosted by the registered runtime providers 460. For example, the runtime broker 450 may receive requests to spawn agent actors (e.g., post calls) and requests to delete agent actors (e.g., delete calls) from the applications 465. In some cases, a request to spawn an agent actor may indicate a provider domain, an agent actor persona (e.g., as described with respect to FIG. 3), an identifier (e.g., an actor name, such as the identifier 310 described with respect to FIG. 3), an agent actor configuration (e.g., indicating a goal, task, or other purpose), or any combination thereof. In some cases, a request to delete an agent actor may indicate the provider domain, the identifier, or both. The runtime broker 450 may forward requests to spawn and delete agent actors to corresponding runtime providers 460 for execution based on the provider domain and agent actor identifier indicated in the request. In some cases, the forwarded requests for spawning may indicate the agent actor persona, the agent actor identifier, and the actor configuration, and the forwarded requests for deleting may indicate the agent actor identifier.

The runtime broker 450 may also include a message endpoint 480. For example, the message endpoint 480 may allow applications 465 to send messages (e.g., such as messages 220 and 320 described with respect to FIGS. 2 and 3) to existing agent actors implemented by the runtime providers 460. The runtime broker 450 may receive the messages (e.g., post calls) from the applications 465 at the message endpoint 480, and the runtime broker 450 may forward the messages to corresponding runtime providers 460. For example, the messages received at the runtime broker 450 may indicate a provider domain, an agent actor identifier, a content of the message, or any combination thereof. In some cases, the forwarded messages from the runtime broker 450 to the runtime provider 460 may indicate the agent actor identifier and the content of the messages.

Based on the messages and requests communicated with the runtime broker 450, the runtime providers 460 may host (e.g., run, provide resources for, implement) one or more agent actors to perform tasks, as described with respect to FIGS. 5A and 5B. In some cases, such a runtime broker model may allow a user to access and utilize agent actors via a distributed (e.g., cloud based) system, which may reduce resource draw at a user device. The runtime broker model 400 may also reduce error propagation in the distributed system associated with the agent actors and increase computational efficiency in implementing the agent actors.

FIGS. 5A and 5B shows an example of runtime provider models 500 (e.g., a runtime provider model 500-a and a runtime provider model 500-b, ART provider models) that support an agent actor management framework in accordance with aspects of the present disclosure. In some cases, aspects of the runtime provider models 500 may implement or be implemented by aspects of FIGS. 1-4. For example, the runtime provider models 500 may illustrate operations of a runtime provider 560, which may be an example of the runtime providers 460 described with respect to FIG. 4 and the runtime providers 360 described with respect to FIG. 3. In some aspects, the runtime provider models 500 may illustrate communication between a runtime broker (e.g., such as the runtime broker 450 of FIG. 4) and a runtime provider 560, as well as techniques for a runtime provider 560 to host (e.g., provide resources for, run, implement) one or more agent actors 505 in a distributed manner, which may reduce error propagation and increase computational efficiency in an ART system (e.g., such as the runtime system 300 of FIG. 3).

In some cases, the runtime provider 560 may supply resources, such as power resources, memory resources (e.g., random access memory (RAM)), and computational resources (e.g., one or more processors) to run agent actors 505 that may be spawned according to the requests of users or applications (e.g., as described with respect to FIG. 4). For example, the runtime provider 560 may receive messages 520 for one or more agent actors and route the messages 520 to corresponding agent actors 505 based on an indicated agent actor identifier (e.g., as described with respect to FIGS. 2 and 4). The runtime provider 560 may cause agent actors 505 to perform actions in response to the messages 520 based on a behavioral state and behaviors of the agent actors 505 (e.g., as described with respect to FIG. 2) using computational resources available to the runtime provider 560.

Each runtime provider 560 may belong to a provider domain (e.g., such as the provider domains 355 described with respect to FIG. 3). In some cases, the provider domain of a runtime provider 560 may determine or indicate one or more agent actor personas (e.g., behaviors, accepted messages) that the runtime provider 560 is capable of spawning and running. For example, all runtime providers 560 within a same provider domain may run instances of a subset of possible agent actor personas based on the associated provider domain.

In some cases, the runtime provider 560 may receive requests and message (e.g., calls) from the runtime broker (e.g., exclusively from the runtime broker) through one or more endpoints in an API/services layer 585 of the runtime provider 560. For example, the API/services layer 585 may include an actor endpoint 535 and a message endpoint 540, which may function similarly to like endpoints in the runtime broker (e.g., the actor endpoint 475 and the message endpoint 480, as described with respect to FIG. 4). However, received messages 520 at the message endpoint 540 and requests to spawn (e.g., post calls) or delete (e.g., delete calls) agent actors 505 at the actor endpoint 535 may not explicitly indicate the provider domain associated with the runtime provider 560, as the provider domain may be implicitly understood by the runtime provider 560. Alternatively, some communications received at the runtime provider 560 may explicitly indicate the provider domain.

The API/services layer 585 may also include an active status 595, which may indicate if the runtime provider 560 is available to host agent actors 505. For example, if the runtime provider 560 loses power, is at a reduced capability, or is otherwise unavailable to host one or more agent actors, the active status 595 may be inactive. Otherwise, the active status 595 may remain active. The runtime provider 560 may send periodic indications (e.g., once per regular interval of time, at least once per specified timeout period) of the active status 595 to the runtime broker to indicate whether the runtime provider 560 is available. In some cases, if the runtime broker does not receive the periodic indication from the runtime provider 560 for one or more regular intervals of time (e.g., a threshold quantity of consecutive intervals of time), the runtime broker may assume that the runtime provider 560 is inactive, and may deregister the runtime provider 560 from the runtime broker. That is, the runtime provider 560 may remain registered to the runtime broker as long as the runtime broker continues to receive the periodic indications of the active status 595 from the runtime provider 560. Alternatively, the periodic indication may indicate whether the runtime provider 560 is available (e.g., a first value or code may indicate availability and a second value or code may indicate unavailability), and the runtime broker may deregister the runtime provider 560 if the periodic indication indicates that the runtime provider 560 is unavailable.

To manage the computational resources for the agent actors 505, the runtime provider 560 may employ various techniques. In one example illustrated by the runtime provider model 500-a, the runtime provider 560 may employ a thread-mapping-based technique to run the agent actors 505. In another example illustrated by the runtime provider model 500-b, the runtime provider 560 may employ a coordinated-workers-based technique to run the agent actors 505.

Regarding the runtime provider model 500-a, within a same computing boundary (e.g., within the same one or more servers, processors, or other computing device), the agent actors 505 may share some characteristics with concurrent actors. In a concurrent actor framework, each actor may be modeled as a long-lived instance that has a small memory footprint and is associated with (e.g., loosely mapped to) a thread of the computing boundary. For example, a server of the runtime provider 560 may be capable of running a quantity of threads (e.g., 8 threads), and the processes that are run to implement each agent actor 505 may be performed partly or entirely by a subset (e.g., one) of the quantity of threads. In such a model, each agent actor 505 may be exposed to the API/services layer 585 via a guardian actor 590, which may be referred to as a “spawning pool.” In some cases, the guardian actor 590 may serve as an intermediary layer in the runtime provider 560 for handling API calls related to lifecycle management of the agent actors 505 (e.g., spawning, deleting) and for receiving and routing messages 520 to and from the agent actors 505. Thus, as each thread may perform processes concurrently with other threads, each runtime provider 560 may host one or more agent actors 505 for users or applications in a distributed manner that decreases error propagation to the agent actors and increases computational efficiency in the distributed system.

Regarding the runtime provider model 500-b, the runtime provider 560 may employ the coordinated-workers-based techniques. For example, the coordinated-workers-based technique may include a message queue (MQ)-based infrastructure, where a queue of messages for all agent actors implemented by the runtime provider 560 may be stored in a mailbox table 515, and one or more actor executors 550 may perform tasks on behalf of the agent actors in a coordinated manner. For example, while each agent actor may be modeled as a container with an identifier, mailbox, behaviors, and behavioral state (e.g., such as describe with respect to FIG. 2), each component of an agent actor may be dispersed in the runtime provider 560 and implemented by actor executors 550 of the runtime provider 560. For example, each actor executor 550 may be associated with a thread of the runtime provider 560, or may represent sufficient computational resources at the runtime provider 560 to implement an agent actor.

In the coordinated-worker-based technique, the runtime provider 560 may store agent actor context 530 received from the runtime broker in a serialized manner to be accessed by the actor executors 550. For example, the agent actor context 530 may include agent actor personas and identifiers indicated in spawning requests, messages 520 for the agent actors, and other information from a runtime broker for the runtime provider 560. In some cases, the runtime provider 560 may store serialized agent actor personas in the agent actor reference table 510 (e.g., including the behaviors 225, the behavioral states 230, the identifiers 210, or any combination thereof, as described with respect to FIG. 2) for multiple agent actors implemented at the runtime provider 560. Additionally, or alternatively, the runtime provider 560 may store messages 520 for all agent actors in a serialized manner in the mailbox table 515. Additionally, or alternatively, in response to storing a message 520 in the mailbox table 515, the runtime provider 560 may store a trigger in a queue 525 of the runtime provider 560, where the actor executors 550 (e.g., generic executors) may listening for the trigger in the queue 525 to begin performing tasks for an agent actor.

To spawn a new agent actor (e.g., an agent actor instance) in the coordinated-worker-based technique (e.g., after an agent actor persona is made for the agent actor), the runtime provider 560 may create a new instance of the agent actor persona (e.g., behaviors, behavioral state, accepted messages) and may store the agent actor persona along with an associated identifier in the agent actor reference table 510. To route a message 520 to a corresponding agent actor, the runtime provider 560 may insert the message 520 in the mailbox table 515, where the message 520 may be keyed with an identifier of the corresponding agent actor. To initiate the actor executors 550 processing the messages 520 in the mailbox table 515, the runtime provider 560 may store the identifier in the queue 525 as a trigger. In response to detecting the trigger, an actor executor 550-a may obtain (e.g., receive, the runtime provider may cause the actor executor to obtain) the identifier from the queue 525 to begin processing the message(s) 520 for the agent actor associated with the identifier.

To reduce error propagation by limiting the quantity of actor executors 550 that are processing messages 520 for a single agent actor, the runtime provider 560 may include an executor lock table 545. For example, the executor lock table 545 may include a lock for each agent actor that the runtime provider 560 is hosting. After the actor executor 550-a obtains the identifier for the agent actor from the queue 525, the actor executor 550-a may attempt to obtain a lock associated with the agent actor from the executor lock table 545, which will allow the actor executor 550-a to process messages 520 and perform tasks on behalf of the agent actor. The executor lock table 545 (e.g., the runtime provider 560) may give the lock to the actor executor 550-a, and may update an entry in the executor lock table 545 to indicate that the actor executor 550-a is currently operating on behalf of the agent actor. If an actor executor 550-b obtains the same identifier for the same agent actor from the queue 525 (e.g., based on another message 520 being stored to the mailbox table 515 for the agent actor) while the actor executor 550-a is operating on behalf of the agent actor, the actor executor 550-b may fail to obtain the lock for the agent actor from the executor lock table 545 based on the actor executor 550-a currently processing messages for the agent actor. In such a case, the actor executor 550-b may terminate the attempt to operate on behalf of the agent actor to maintain serialization of processing for the agent actor and reduce errors. Is this way, actor executors 550 may operate concurrently on behalf of different agent actors, but may not operate concurrently on behalf of the same agent actor, to increase computational efficiency without affecting data security.

After obtaining the identifier from the queue 525 (e.g., and possibly after obtaining the lock from the executor lock table 545), the actor executor 550-a may load (e.g., obtain) the agent actor persona (e.g., serialized behavior, a behavioral state) from the agent actor reference table 510. In response to loading the agent actor persona, the actor executor 550-a may begin processing messages 520 for the agent actor from the mailbox table 515 by applying the message 520 to the behavior of the agent actor one at a time until the mailbox table 515 no longer contains messages 520 for the agent actor. Applying the messages 520 to the behavior may include performing one or more of the tasks described with respect to FIG. 2, including updating the behavioral state of the agent actor and utilizing other tools. After processing each message 520 in the mailbox table 515 for the agent actor, the actor executor 550-a may save the updated behavioral state (e.g., update the behavioral state) of the agent actor back to the agent actor reference table 510. Additionally, or alternatively, the actor executor 550-a may indicate (e.g., to the executor lock table 545, to the runtime provider 560) that the lock for the agent actor is no longer being used, and the runtime provider 560 may update the entry in the executor lock table 545 to indicate that the lock for the agent actor is available. The actor executor 550-a may obtain another identifier from the queue 525 or exit and listen for new triggers in the queue 525.

According to the techniques described herein, a framework to treat agents actors as a fundamental building block available to users and applications (e.g., the ART system, the runtime system 300) may be employed in a distributed manner to reduce resource usage at a user device for implementing agent actors. The framework may also reduce error propagation associated with hosting agent actors and may increase computational efficiency for implementing agent actors in the various components (e.g., servers, processors, runtime providers, runtime brokers) of a distributed (e.g., cloud-based) system.

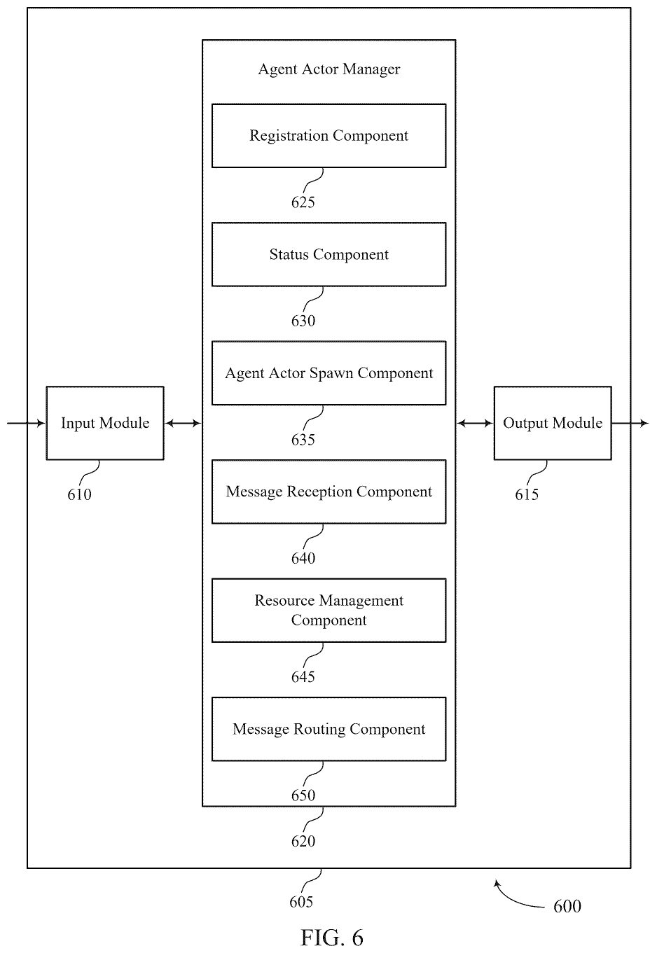

FIG. 6 shows a block diagram 600 of a device 605 that supports agent actor management framework in accordance with aspects of the present disclosure. The device 605 may include an input module 610, an output module 615, and an agent actor manager 620. The device 605, or one or more components of the device 605 (e.g., the input module 610, the output module 615, the agent actor manager 620), may include at least one processor, which may be coupled with at least one memory, to support the described techniques. Each of these components may be in communication with one another (e.g., via one or more buses).

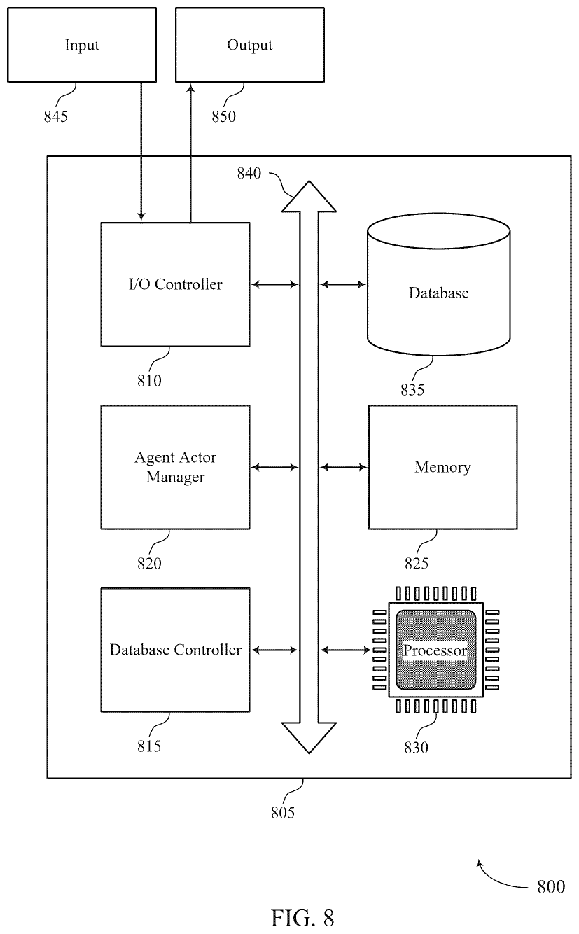

The input module 610 may manage input signals for the device 605. For example, the input module 610 may identify input signals based on an interaction with a modem, a keyboard, a mouse, a touchscreen, or a similar device. These input signals may be associated with user input or processing at other components or devices. In some cases, the input module 610 may utilize an operating system such as iOS®, ANDROID®, MS-DOS®, MS-WINDOWS®, OS/2®, UNIX®, LINUX®, or another known operating system to handle input signals. The input module 610 may send aspects of these input signals to other components of the device 605 for processing. For example, the input module 610 may transmit input signals to the agent actor manager 620 to support agent actor management framework. In some cases, the input module 610 may be a component of an input/output (I/O) controller 810 as described with reference to FIG. 8.

The output module 615 may manage output signals for the device 605. For example, the output module 615 may receive signals from other components of the device 605, such as the agent actor manager 620, and may transmit these signals to other components or devices. In some examples, the output module 615 may transmit output signals for display in a user interface, for storage in a database or data store, for further processing at a server or server cluster, or for any other processes at any number of devices or systems. In some cases, the output module 615 may be a component of an I/O controller 810 as described with reference to FIG. 8.

For example, the agent actor manager 620 may include a registration component 625, a status component 630, an agent actor spawn component 635, a message reception component 640, a resource management component 645, a message routing component 650, or any combination thereof. In some examples, the agent actor manager 620, or various components thereof, may be configured to perform various operations (e.g., receiving, monitoring, transmitting) using or otherwise in cooperation with the input module 610, the output module 615, or both. For example, the agent actor manager 620 may receive information from the input module 610, send information to the output module 615, or be integrated in combination with the input module 610, the output module 615, or both to receive information, transmit information, or perform various other operations as described herein.

The agent actor manager 620 may support data processing in accordance with examples as disclosed herein. The registration component 625 may be configured to support transmitting, from a runtime provider to a runtime broker, a registration message indicating a provider domain associated with the runtime provider and an address associated with the runtime provider. The status component 630 may be configured to support transmitting, at a regular interval to the runtime broker, an indication of an active status of the runtime provider based on transmitting the registration message. The agent actor spawn component 635 may be configured to support receiving, from the runtime broker based on the indication of the active status, a request to spawn an agent actor assigned to a task based on the provider domain, the request indicating an identifier associated with the agent actor. The agent actor spawn component 635 may be configured to support spawning the agent actor in response to the request. The message reception component 640 may be configured to support receiving, from the runtime broker based on the indication of the active status, a message indicating the identifier associated with the agent actor and context information associated with the task assigned to the agent actor. The message reception component 640 may be configured to support routing the message to the agent actor associated with the identifier based on receiving the message. The resource management component 645 may be configured to support managing computational resources for the agent actor based on spawning the agent actor and routing the message to the agent actor.

Additionally, or alternatively, the agent actor manager 620 may support data processing in accordance with examples as disclosed herein. The registration component 625 may be configured to support receiving, at a runtime broker from a runtime provider, a registration message indicating a provider domain and an address associated with the runtime provider. The status component 630 may be configured to support receiving, at a regular interval from the runtime provider, an indication of an active status of the runtime provider based on receiving the registration message. The agent actor spawn component 635 may be configured to support receiving, from an application, a first request to spawn an agent actor, where the first request indicates the provider domain and an identifier associated with the agent actor. The agent actor spawn component 635 may be configured to support transmitting, to the runtime provider in response to receiving the first request, a second request to spawn the agent actor based on the provider domain, the second request indicating the identifier associated with the agent actor. The message reception component 640 may be configured to support receiving a message indicating the provider domain, the identifier associated with the agent actor, and context information associated with a task assigned to the agent actor. The message routing component 650 may be configured to support routing the message to the runtime provider based on the identifier associated with the agent actor, the provider domain, or both.

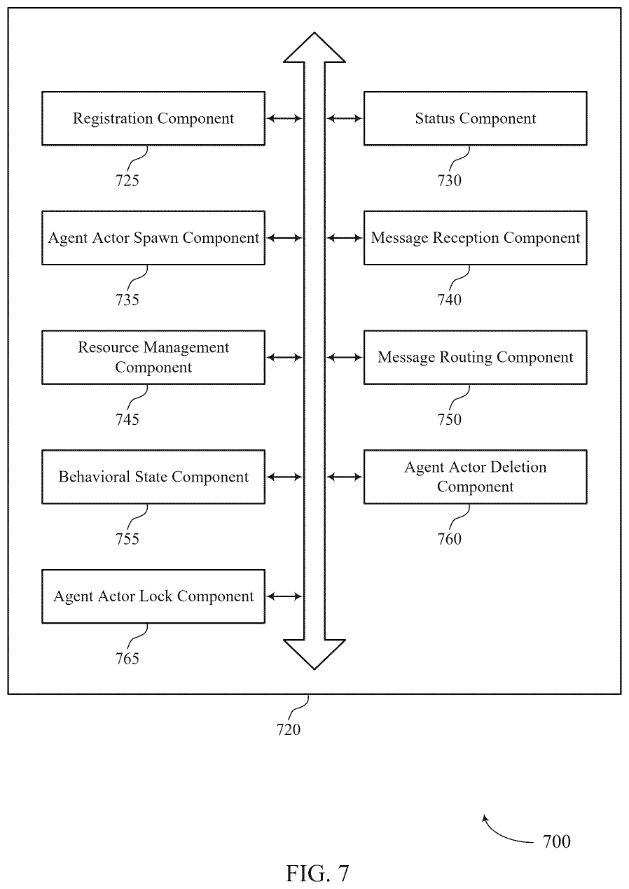

FIG. 7 shows a block diagram 700 of an agent actor manager 720 that supports agent actor management framework in accordance with aspects of the present disclosure. The agent actor manager 720 may be an example of aspects of an agent actor manager or an agent actor manager 620, or both, as described herein. The agent actor manager 720, or various components thereof, may be an example of means for performing various aspects of agent actor management framework as described herein. For example, the agent actor manager 720 may include a registration component 725, a status component 730, an agent actor spawn component 735, a message reception component 740, a resource management component 745, a message routing component 750, a behavioral state component 755, an agent actor deletion component 760, an agent actor lock component 765, or any combination thereof. Each of these components, or components of subcomponents thereof (e.g., one or more processors, one or more memories), may communicate, directly or indirectly, with one another (e.g., via one or more buses).

The agent actor manager 720 may support data processing in accordance with examples as disclosed herein. The registration component 725 may be configured to support transmitting, from a runtime provider to a runtime broker, a registration message indicating a provider domain associated with the runtime provider and an address associated with the runtime provider. The status component 730 may be configured to support transmitting, at a regular interval to the runtime broker, an indication of an active status of the runtime provider based on transmitting the registration message. The agent actor spawn component 735 may be configured to support receiving, from the runtime broker based on the indication of the active status, a request to spawn an agent actor assigned to a task based on the provider domain, the request indicating an identifier associated with the agent actor. In some examples, the agent actor spawn component 735 may be configured to support spawning the agent actor in response to the request. The message reception component 740 may be configured to support receiving, from the runtime broker based on the indication of the active status, a message indicating the identifier associated with the agent actor and context information associated with the task assigned to the agent actor. In some examples, the message reception component 740 may be configured to support routing the message to the agent actor associated with the identifier based on receiving the message. The resource management component 745 may be configured to support managing computational resources for the agent actor based on spawning the agent actor and routing the message to the agent actor.

In some examples, the resource management component 745 may be configured to support associating the agent actor with a corresponding thread of one or more processing devices of the runtime provider.

In some examples, to support routing the message to the agent actor associated with the identifier, the message reception component 740 may be configured to support routing, via a guardian actor of the runtime provider, the message from an application programming interface of the runtime provider to the agent actor.

In some examples, spawning the agent actor includes storing a behavioral state associated with the agent actor and the identifier in a first table, where one or more actor executors managed by the runtime provider are capable of accessing and updating the behavioral state in the first table based on one or more messages received at the runtime provider. In some examples, receiving the message indicating the identifier associated with the agent actor includes storing the message and the identifier in a second table accessible to the one or more actor executors.

In some examples, to support routing the message to the agent actor associated with the identifier, the message reception component 740 may be configured to support storing the identifier associated with the agent actor in a queue accessible to the one or more actor executors at the runtime provider, where the stored identifier includes a trigger for an actor executor of the one or more actor executors to perform one or more actions in response to the message stored in the second table and according to the behavioral state stored in the first table based on the identifier.

In some examples, the agent actor lock component 765 may be configured to support maintaining a database of one or more locks corresponding to the one or more actor executors, where a lock of the one or more locks indicates whether a second actor executor of the one or more actor executors is currently retrieving the message from the second table, retrieving the behavioral state, or performing the one or more actions based on the stored identifier.

In some examples, the behavioral state component 755 may be configured to support updating the behavioral state of the agent actor in the first table in response to the actor executor performing the one or more actions in response to the message.

Additionally, or alternatively, the agent actor manager 720 may support data processing in accordance with examples as disclosed herein. In some examples, the registration component 725 may be configured to support receiving, at a runtime broker from a runtime provider, a registration message indicating a provider domain and an address associated with the runtime provider. In some examples, the status component 730 may be configured to support receiving, at a regular interval from the runtime provider, an indication of an active status of the runtime provider based on receiving the registration message. In some examples, the agent actor spawn component 735 may be configured to support receiving, from an application, a first request to spawn an agent actor, where the first request indicates the provider domain and an identifier associated with the agent actor. In some examples, the agent actor spawn component 735 may be configured to support transmitting, to the runtime provider in response to receiving the first request, a second request to spawn the agent actor based on the provider domain, the second request indicating the identifier associated with the agent actor. In some examples, the message reception component 740 may be configured to support receiving a message indicating the provider domain, the identifier associated with the agent actor, and context information associated with a task assigned to the agent actor. The message routing component 750 may be configured to support routing the message to the runtime provider based on the identifier associated with the agent actor, the provider domain, or both.

In some examples, the registration component 725 may be configured to support adding the runtime provider to a registry of one or more runtime providers maintained at the runtime broker based on receiving the registration message from the runtime provider.

In some examples, the registration component 725 may be configured to support receiving, at the runtime broker from the application, a deregistration message indicating the provider domain and the address associated with the runtime provider. In some examples, the registration component 725 may be configured to support removing the runtime provider from the registry of the one or more runtime providers based on receiving the deregistration message.

In some examples, the registration component 725 may be configured to support removing the runtime provider from the registry of the one or more runtime providers based on determining that the regular interval has elapsed without receiving the indication of the active status of the runtime provider.

In some examples, the agent actor deletion component 760 may be configured to support receiving, from the application, a third request to delete the agent actor, where the second request indicates the provider domain and the identifier associated with the agent actor. In some examples, the agent actor deletion component 760 may be configured to support transmitting, to the runtime provider, the third request to delete the agent actor based on the provider domain and the identifier associated with the agent actor.

FIG. 8 shows a diagram of a system 800 including a device 805 that supports agent actor management framework in accordance with aspects of the present disclosure. The device 805 may be an example of or include components of a device 605 as described herein. The device 805 may include components for bi-directional data communications including components for transmitting and receiving communications, such as an agent actor manager 820, an I/O controller, such as an I/O controller 810, a database controller 815, at least one memory 825, at least one processor 830, and a database 835. These components may be in electronic communication or otherwise coupled (e.g., operatively, communicatively, functionally, electronically, electrically) via one or more buses (e.g., a bus 840).

The I/O controller 810 may manage input signals 845 and output signals 850 for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. In other cases, the I/O controller 810 may represent or interact with a modem, a keyboard, a mouse, a touchscreen, or a similar device. In some cases, the I/O controller 810 may be implemented as part of a processor 830. In some examples, a user may interact with the device 805 via the I/O controller 810 or via hardware components controlled by the I/O controller 810.

The database controller 815 may manage data storage and processing in a database 835. In some cases, a user may interact with the database controller 815. In other cases, the database controller 815 may operate automatically without user interaction. The database 835 may be an example of a single database, a distributed database, multiple distributed databases, a data store, a data lake, or an emergency backup database.

Memory 825 may include random-access memory (RAM) and read-only memory (ROM). The memory 825 may store computer-readable, computer-executable software including instructions that, when executed, cause at least one processor 830 to perform various functions described herein. In some cases, the memory 825 may contain, among other things, a basic I/O system (BIOS) which may control basic hardware or software operation such as the interaction with peripheral components or devices. The memory 825 may be an example of a single memory or multiple memories. For example, the device 805 may include one or more memories 825.

The processor 830 may include an intelligent hardware device (e.g., a general-purpose processor, a digital signal processor (DSP), a central processing unit (CPU), a microcontroller, an application-specific integrated circuit (ASIC), a field-programmable gate array (FPGA), a programmable logic device, a discrete gate or transistor logic component, a discrete hardware component, or any combination thereof). In some cases, the processor 830 may be configured to operate a memory array using a memory controller. In other cases, a memory controller may be integrated into the processor 830. The processor 830 may be configured to execute computer-readable instructions stored in at least one memory 825 to perform various functions (e.g., functions or tasks supporting agent actor management framework). The processor 830 may be an example of a single processor or multiple processors. For example, the device 805 may include one or more processors 830.

The agent actor manager 820 may support data processing in accordance with examples as disclosed herein. For example, the agent actor manager 820 may be configured to support transmitting, from a runtime provider to a runtime broker, a registration message indicating a provider domain associated with the runtime provider and an address associated with the runtime provider. The agent actor manager 820 may be configured to support transmitting, at a regular interval to the runtime broker, an indication of an active status of the runtime provider based on transmitting the registration message. The agent actor manager 820 may be configured to support receiving, from the runtime broker based on the indication of the active status, a request to spawn an agent actor assigned to a task based on the provider domain, the request indicating an identifier associated with the agent actor. The agent actor manager 820 may be configured to support spawning the agent actor in response to the request. The agent actor manager 820 may be configured to support receiving, from the runtime broker based on the indication of the active status, a message indicating the identifier associated with the agent actor and context information associated with the task assigned to the agent actor. The agent actor manager 820 may be configured to support routing the message to the agent actor associated with the identifier based on receiving the message. The agent actor manager 820 may be configured to support managing computational resources for the agent actor based on spawning the agent actor and routing the message to the agent actor.

Additionally, or alternatively, the agent actor manager 820 may support data processing in accordance with examples as disclosed herein. For example, the agent actor manager 820 may be configured to support receiving, at a runtime broker from a runtime provider, a registration message indicating a provider domain and an address associated with the runtime provider. The agent actor manager 820 may be configured to support receiving, at a regular interval from the runtime provider, an indication of an active status of the runtime provider based on receiving the registration message. The agent actor manager 820 may be configured to support receiving, from an application, a first request to spawn an agent actor, where the first request indicates the provider domain and an identifier associated with the agent actor. The agent actor manager 820 may be configured to support transmitting, to the runtime provider in response to receiving the first request, a second request to spawn the agent actor based on the provider domain, the second request indicating the identifier associated with the agent actor. The agent actor manager 820 may be configured to support receiving a message indicating the provider domain, the identifier associated with the agent actor, and context information associated with a task assigned to the agent actor. The agent actor manager 820 may be configured to support routing the message to the runtime provider based on the identifier associated with the agent actor, the provider domain, or both.

By including or configuring the agent actor manager 820 in accordance with examples as described herein, the device 805 may support techniques for reduced latency, improved user experience related to reduced processing, and reduced power consumption. For example, a user device utilizing the techniques described herein may utilize less resources to implement agent actors, and servers implementing the ART-broker and ART-providers may coordinate in a manner to reduce error propagation and increase scalability.

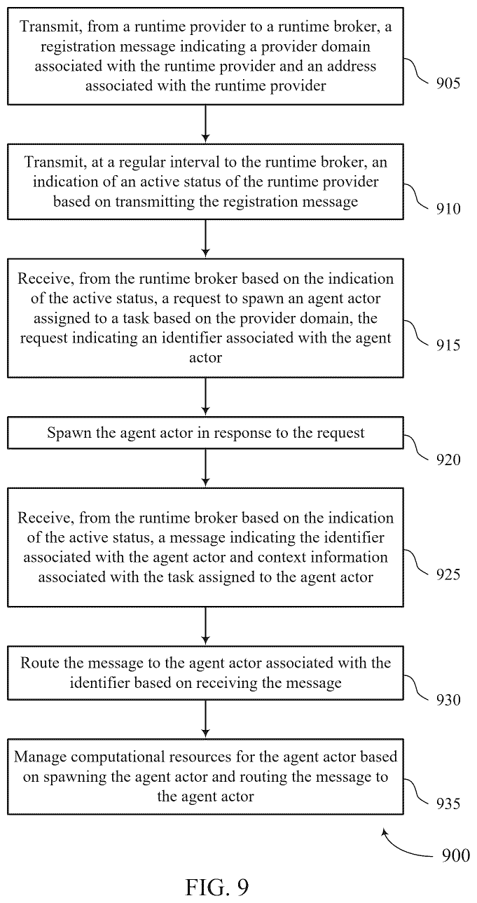

FIG. 9 shows a flowchart illustrating a method 900 that supports agent actor management framework in accordance with aspects of the present disclosure. The operations of the method 900 may be implemented by a server or its components as described herein. For example, the operations of the method 900 may be performed by a server as described with reference to FIGS. 1 through 8. In some examples, a server may execute a set of instructions to control the functional elements of the server to perform the described functions. Additionally, or alternatively, the server may perform aspects of the described functions using special-purpose hardware.

At 905, the method may include transmitting, from a runtime provider to a runtime broker, a registration message indicating a provider domain associated with the runtime provider and an address associated with the runtime provider. The operations of 905 may be performed in accordance with examples as disclosed herein. In some examples, aspects of the operations of 905 may be performed by a registration component 725 as described with reference to FIG. 7.

At 910, the method may include transmitting, at a regular interval to the runtime broker, an indication of an active status of the runtime provider based on transmitting the registration message. The operations of 910 may be performed in accordance with examples as disclosed herein. In some examples, aspects of the operations of 910 may be performed by a status component 730 as described with reference to FIG. 7.

At 915, the method may include receiving, from the runtime broker based on the indication of the active status, a request to spawn an agent actor assigned to a task based on the provider domain, the request indicating an identifier associated with the agent actor. The operations of 915 may be performed in accordance with examples as disclosed herein. In some examples, aspects of the operations of 915 may be performed by an agent actor spawn component 735 as described with reference to FIG. 7.

At 920, the method may include spawning the agent actor in response to the request. The operations of 920 may be performed in accordance with examples as disclosed herein. In some examples, aspects of the operations of 920 may be performed by an agent actor spawn component 735 as described with reference to FIG. 7.

At 925, the method may include receiving, from the runtime broker based on the indication of the active status, a message indicating the identifier associated with the agent actor and context information associated with the task assigned to the agent actor. The operations of 925 may be performed in accordance with examples as disclosed herein. In some examples, aspects of the operations of 925 may be performed by a message reception component 740 as described with reference to FIG. 7.

At 930, the method may include routing the message to the agent actor associated with the identifier based on receiving the message. The operations of 930 may be performed in accordance with examples as disclosed herein. In some examples, aspects of the operations of 930 may be performed by a message reception component 740 as described with reference to FIG. 7.

At 935, the method may include managing computational resources for the agent actor based on spawning the agent actor and routing the message to the agent actor. The operations of 935 may be performed in accordance with examples as disclosed herein. In some examples, aspects of the operations of 935 may be performed by a resource management component 745 as described with reference to FIG. 7.

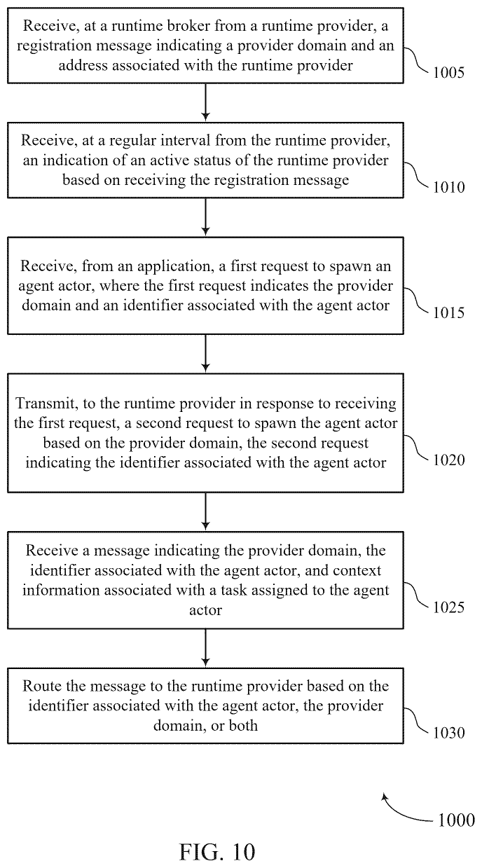

FIG. 10 shows a flowchart illustrating a method 1000 that supports agent actor management framework in accordance with aspects of the present disclosure. The operations of the method 1000 may be implemented by a server or its components as described herein. For example, the operations of the method 1000 may be performed by a server as described with reference to FIGS. 1 through 8. In some examples, a server may execute a set of instructions to control the functional elements of the server to perform the described functions. Additionally, or alternatively, the server may perform aspects of the described functions using special-purpose hardware.

At 1005, the method may include receiving, at a runtime broker from a runtime provider, a registration message indicating a provider domain and an address associated with the runtime provider. The operations of 1005 may be performed in accordance with examples as disclosed herein. In some examples, aspects of the operations of 1005 may be performed by a registration component 725 as described with reference to FIG. 7.

At 1010, the method may include receiving, at a regular interval from the runtime provider, an indication of an active status of the runtime provider based on receiving the registration message. The operations of 1010 may be performed in accordance with examples as disclosed herein. In some examples, aspects of the operations of 1010 may be performed by a status component 730 as described with reference to FIG. 7.

At 1015, the method may include receiving, from an application, a first request to spawn an agent actor, where the first request indicates the provider domain and an identifier associated with the agent actor. The operations of 1015 may be performed in accordance with examples as disclosed herein. In some examples, aspects of the operations of 1015 may be performed by an agent actor spawn component 735 as described with reference to FIG. 7.

At 1020, the method may include transmitting, to the runtime provider in response to receiving the first request, a second request to spawn the agent actor based on the provider domain, the second request indicating the identifier associated with the agent actor. The operations of 1020 may be performed in accordance with examples as disclosed herein. In some examples, aspects of the operations of 1020 may be performed by an agent actor spawn component 735 as described with reference to FIG. 7.

At 1025, the method may include receiving a message indicating the provider domain, the identifier associated with the agent actor, and context information associated with a task assigned to the agent actor. The operations of 1025 may be performed in accordance with examples as disclosed herein. In some examples, aspects of the operations of 1025 may be performed by a message reception component 740 as described with reference to FIG. 7.

At 1030, the method may include routing the message to the runtime provider based on the identifier associated with the agent actor, the provider domain, or both. The operations of 1030 may be performed in accordance with examples as disclosed herein. In some examples, aspects of the operations of 1030 may be performed by a message routing component 750 as described with reference to FIG. 7.

A method for data processing by an apparatus is described. The method may include transmitting, from a runtime provider to a runtime broker, a registration message indicating a provider domain associated with the runtime provider and an address associated with the runtime provider, transmitting, at a regular interval to the runtime broker, an indication of an active status of the runtime provider based on transmitting the registration message, receiving, from the runtime broker based on the indication of the active status, a request to spawn an agent actor assigned to a task based on the provider domain, the request indicating an identifier associated with the agent actor, spawning the agent actor in response to the request, receiving, from the runtime broker based on the indication of the active status, a message indicating the identifier associated with the agent actor and context information associated with the task assigned to the agent actor, routing the message to the agent actor associated with the identifier based on receiving the message, and managing computational resources for the agent actor based on spawning the agent actor and routing the message to the agent actor.

An apparatus for data processing is described. The apparatus may include one or more memories storing processor executable code, and one or more processors coupled with the one or more memories. The one or more processors may individually or collectively be operable to execute the code to cause the apparatus to transmit, from a runtime provider to a runtime broker, a registration message indicating a provider domain associated with the runtime provider and an address associated with the runtime provider, transmit, at a regular interval to the runtime broker, an indication of an active status of the runtime provider based on transmitting the registration message, receive, from the runtime broker based on the indication of the active status, a request to spawn an agent actor assigned to a task based on the provider domain, the request indicating an identifier associated with the agent actor, spawn the agent actor in response to the request, receive, from the runtime broker based on the indication of the active status, a message indicating the identifier associated with the agent actor and context information associated with the task assigned to the agent actor, route the message to the agent actor associated with the identifier based on receiving the message, and manage computational resources for the agent actor based on spawning the agent actor and routing the message to the agent actor.

Another apparatus for data processing is described. The apparatus may include means for transmitting, from a runtime provider to a runtime broker, a registration message indicating a provider domain associated with the runtime provider and an address associated with the runtime provider, means for transmitting, at a regular interval to the runtime broker, an indication of an active status of the runtime provider based on transmitting the registration message, means for receiving, from the runtime broker based on the indication of the active status, a request to spawn an agent actor assigned to a task based on the provider domain, the request indicating an identifier associated with the agent actor, means for spawning the agent actor in response to the request, means for receiving, from the runtime broker based on the indication of the active status, a message indicating the identifier associated with the agent actor and context information associated with the task assigned to the agent actor, means for routing the message to the agent actor associated with the identifier based on receiving the message, and means for managing computational resources for the agent actor based on spawning the agent actor and routing the message to the agent actor.

A non-transitory computer-readable medium storing code for data processing is described. The code may include instructions executable by one or more processors to transmit, from a runtime provider to a runtime broker, a registration message indicating a provider domain associated with the runtime provider and an address associated with the runtime provider, transmit, at a regular interval to the runtime broker, an indication of an active status of the runtime provider based on transmitting the registration message, receive, from the runtime broker based on the indication of the active status, a request to spawn an agent actor assigned to a task based on the provider domain, the request indicating an identifier associated with the agent actor, spawn the agent actor in response to the request, receive, from the runtime broker based on the indication of the active status, a message indicating the identifier associated with the agent actor and context information associated with the task assigned to the agent actor, route the message to the agent actor associated with the identifier based on receiving the message, and manage computational resources for the agent actor based on spawning the agent actor and routing the message to the agent actor.

Some examples of the method, apparatus, and non-transitory computer-readable medium described herein may further include operations, features, means, or instructions for associating the agent actor with a corresponding thread of one or more processing devices of the runtime provider.

In some examples of the method, apparatus, and non-transitory computer-readable medium described herein, routing the message to the agent actor associated with the identifier may include operations, features, means, or instructions for routing, via a guardian actor of the runtime provider, the message from an application programming interface of the runtime provider to the agent actor.

Some examples of the method, apparatus, and non-transitory computer-readable medium described herein may further include operations, features, means, or instructions for spawning the agent actor includes storing a behavioral state associated with the agent actor and the identifier in a first table, where one or more actor executors managed by the runtime provider may be capable of accessing and updating the behavioral state in the first table based on one or more messages received at the runtime provider and receiving the message indicating the identifier associated with the agent actor includes storing the message and the identifier in a second table accessible to the one or more actor executors.

In some examples of the method, apparatus, and non-transitory computer-readable medium described herein, routing the message to the agent actor associated with the identifier may include operations, features, means, or instructions for storing the identifier associated with the agent actor in a queue accessible to the one or more actor executors at the runtime provider, where the stored identifier includes a trigger for an actor executor of the one or more actor executors to perform one or more actions in response to the message stored in the second table and according to the behavioral state stored in the first table based on the identifier.

Some examples of the method, apparatus, and non-transitory computer-readable medium described herein may further include operations, features, means, or instructions for maintaining a database of one or more locks corresponding to the one or more actor executors, where a lock of the one or more locks indicates whether a second actor executor of the one or more actor executors may be currently retrieving the message from the second table, retrieving the behavioral state, or performing the one or more actions based on the stored identifier.

Some examples of the method, apparatus, and non-transitory computer-readable medium described herein may further include operations, features, means, or instructions for updating the behavioral state of the agent actor in the first table in response to the actor executor performing the one or more actions in response to the message.

A method for data processing by an apparatus is described. The method may include receiving, at a runtime broker from a runtime provider, a registration message indicating a provider domain and an address associated with the runtime provider, receiving, at a regular interval from the runtime provider, an indication of an active status of the runtime provider based on receiving the registration message, receiving, from an application, a first request to spawn an agent actor, where the first request indicates the provider domain and an identifier associated with the agent actor, transmitting, to the runtime provider in response to receiving the first request, a second request to spawn the agent actor based on the provider domain, the second request indicating the identifier associated with the agent actor, receiving a message indicating the provider domain, the identifier associated with the agent actor, and context information associated with a task assigned to the agent actor, and routing the message to the runtime provider based on the identifier associated with the agent actor, the provider domain, or both.

An apparatus for data processing is described. The apparatus may include one or more memories storing processor executable code, and one or more processors coupled with the one or more memories. The one or more processors may individually or collectively be operable to execute the code to cause the apparatus to receive, at a runtime broker from a runtime provider, a registration message indicating a provider domain and an address associated with the runtime provider, receive, at a regular interval from the runtime provider, an indication of an active status of the runtime provider based on receiving the registration message, receive, from an application, a first request to spawn an agent actor, where the first request indicates the provider domain and an identifier associated with the agent actor, transmit, to the runtime provider in response to receiving the first request, a second request to spawn the agent actor based on the provider domain, the second request indicating the identifier associated with the agent actor, receive a message indicating the provider domain, the identifier associated with the agent actor, and context information associated with a task assigned to the agent actor, and route the message to the runtime provider based on the identifier associated with the agent actor, the provider domain, or both.

Another apparatus for data processing is described. The apparatus may include means for receiving, at a runtime broker from a runtime provider, a registration message indicating a provider domain and an address associated with the runtime provider, means for receiving, at a regular interval from the runtime provider, an indication of an active status of the runtime provider based on receiving the registration message, means for receiving, from an application, a first request to spawn an agent actor, where the first request indicates the provider domain and an identifier associated with the agent actor, means for transmitting, to the runtime provider in response to receiving the first request, a second request to spawn the agent actor based on the provider domain, the second request indicating the identifier associated with the agent actor, means for receiving a message indicating the provider domain, the identifier associated with the agent actor, and context information associated with a task assigned to the agent actor, and means for routing the message to the runtime provider based on the identifier associated with the agent actor, the provider domain, or both.

A non-transitory computer-readable medium storing code for data processing is described. The code may include instructions executable by one or more processors to receive, at a runtime broker from a runtime provider, a registration message indicating a provider domain and an address associated with the runtime provider, receive, at a regular interval from the runtime provider, an indication of an active status of the runtime provider based on receiving the registration message, receive, from an application, a first request to spawn an agent actor, where the first request indicates the provider domain and an identifier associated with the agent actor, transmit, to the runtime provider in response to receiving the first request, a second request to spawn the agent actor based on the provider domain, the second request indicating the identifier associated with the agent actor, receive a message indicating the provider domain, the identifier associated with the agent actor, and context information associated with a task assigned to the agent actor, and route the message to the runtime provider based on the identifier associated with the agent actor, the provider domain, or both.

Some examples of the method, apparatus, and non-transitory computer-readable medium described herein may further include operations, features, means, or instructions for adding the runtime provider to a registry of one or more runtime providers maintained at the runtime broker based on receiving the registration message from the runtime provider.

Some examples of the method, apparatus, and non-transitory computer-readable medium described herein may further include operations, features, means, or instructions for receiving, at the runtime broker from the application, a deregistration message indicating the provider domain and the address associated with the runtime provider and removing the runtime provider from the registry of the one or more runtime providers based on receiving the deregistration message.

Some examples of the method, apparatus, and non-transitory computer-readable medium described herein may further include operations, features, means, or instructions for removing the runtime provider from the registry of the one or more runtime providers based on determining that the regular interval may have elapsed without receiving the indication of the active status of the runtime provider.

Some examples of the method, apparatus, and non-transitory computer-readable medium described herein may further include operations, features, means, or instructions for receiving, from the application, a third request to delete the agent actor, where the second request indicates the provider domain and the identifier associated with the agent actor and transmitting, to the runtime provider, the third request to delete the agent actor based on the provider domain and the identifier associated with the agent actor.

Another apparatus data processing is described. The apparatus may include a runtime broker configured to, receive, from a runtime provider, a registration message indicating a provider domain and an address associated with the runtime provider, receive, from an application, a first request to spawn an agent actor, where the first request indicates the provider domain and an identifier associated with the agent actor, transmit, to the runtime provider, a second request to spawn the agent actor based on the provider domain, the second request indicating the identifier associated with the agent actor, the runtime provider configured to, spawn the agent actor in response to receiving the second request, receive, from the runtime broker, a message indicating the identifier associated with the agent actor, the message further indicating context information associated with a task assigned to the agent actor, route the message to the agent actor based on the message indicating the identifier, and manage computational resources for the agent actor based on spawning the agent actor and routing the message to the agent actor.

In some examples of the apparatus, the runtime broker may be further configured to add the runtime provider to a registry of one or more runtime providers maintained at the runtime broker based on receiving the registration message from the runtime provider.

Some examples of the apparatus may further include receiving, at the runtime broker from the application, a deregistration message indicating the provider domain and the address associated with the runtime provider and removing the runtime provider from the registry of the one or more runtime providers based on receiving the deregistration message.

In some examples of the apparatus, the runtime broker may be further configured to remove the runtime provider from the registry of the one or more runtime providers based on determining that a regular interval may have elapsed without receiving an indication of an active status of the runtime provider.

In some examples of the apparatus, the runtime provider may be further configured to associate the agent actor with a corresponding thread of one or more processing devices of the runtime provider.

In some examples of the apparatus, to spawn the agent actor, the runtime provider may be configured to store a behavioral state associated with the agent actor and the identifier in a first table, where one or more actor executors managed by the runtime provider may be capable of accessing and updating the behavioral state in the first table based on one or more messages received at the runtime provider and to receive the message indicating the identifier associated with the agent actor, the runtime provider may be configured to store the message and the identifier in a second table accessible to the one or more actor executors.

In some examples of the apparatus, to route the message to the agent actor associated with the identifier, the runtime provider may be configured to store the identifier associated with the agent actor in a queue accessible to the one or more actor executors at the runtime provider, where the stored identifier includes a trigger for an actor executor of the one or more actor executors to perform one or more actions in response to the message stored in the second table and according to the behavioral state in the first table based on the identifier.

In some examples of the apparatus, the runtime provider may be further configured to maintain a database of one or more locks corresponding to the one or more actor executors, where a lock of the one or more locks indicates whether a second actor executor of the one or more actor executors may be currently retrieving the message from the second table, retrieving the behavioral state, or performing the one or more actions based on the stored identifier.

The following provides an overview of aspects of the present disclosure:

Aspect 1: A method for data processing, comprising: transmitting, from a runtime provider to a runtime broker, a registration message indicating a provider domain associated with the runtime provider and an address associated with the runtime provider; transmitting, at a regular interval to the runtime broker, an indication of an active status of the runtime provider based at least in part on transmitting the registration message; receiving, from the runtime broker based at least in part on the indication of the active status, a request to spawn an agent actor assigned to a task based at least in part on the provider domain, the request indicating an identifier associated with the agent actor; spawning the agent actor in response to the request; receiving, from the runtime broker based at least in part on the indication of the active status, a message indicating the identifier associated with the agent actor and context information associated with the task assigned to the agent actor; routing the message to the agent actor associated with the identifier based at least in part on receiving the message; and managing computational resources for the agent actor based at least in part on spawning the agent actor and routing the message to the agent actor.

Aspect 2: The method of aspect 1, further comprising: associating the agent actor with a corresponding thread of one or more processing devices of the runtime provider.

Aspect 3: The method of any of aspects 1 through 2, wherein routing the message to the agent actor associated with the identifier comprises: routing, via a guardian actor of the runtime provider, the message from an application programming interface of the runtime provider to the agent actor.

Aspect 4: The method of aspect 1, wherein spawning the agent actor comprises storing a behavioral state associated with the agent actor and the identifier in a first table, wherein one or more actor executors managed by the runtime provider are capable of accessing and updating the behavioral state in the first table based at least in part on one or more messages received at the runtime provider; and receiving the message indicating the identifier associated with the agent actor comprises storing the message and the identifier in a second table accessible to the one or more actor executors.

Aspect 5: The method of aspect 4, wherein routing the message to the agent actor associated with the identifier comprises: storing the identifier associated with the agent actor in a queue accessible to the one or more actor executors at the runtime provider, wherein the stored identifier comprises a trigger for an actor executor of the one or more actor executors to perform one or more actions in response to the message stored in the second table and according to the behavioral state stored in the first table based at least in part on the identifier.

Aspect 6: The method of aspect 5, further comprising: maintaining a database of one or more locks corresponding to the one or more actor executors, wherein a lock of the one or more locks indicates whether a second actor executor of the one or more actor executors is currently retrieving the message from the second table, retrieving the behavioral state, or performing the one or more actions based at least in part on the stored identifier.

Aspect 7: The method of any of aspects 5 through 6, further comprising: updating the behavioral state of the agent actor in the first table in response to the actor executor performing the one or more actions in response to the message.

Aspect 8: A method for data processing, comprising: receiving, at a runtime broker from a runtime provider, a registration message indicating a provider domain and an address associated with the runtime provider; receiving, at a regular interval from the runtime provider, an indication of an active status of the runtime provider based at least in part on receiving the registration message; receiving, from an application, a first request to spawn an agent actor, wherein the first request indicates the provider domain and an identifier associated with the agent actor; transmitting, to the runtime provider in response to receiving the first request, a second request to spawn the agent actor based at least in part on the provider domain, the second request indicating the identifier associated with the agent actor; receiving a message indicating the provider domain, the identifier associated with the agent actor, and context information associated with a task assigned to the agent actor; and routing the message to the runtime provider based at least in part on the identifier associated with the agent actor, the provider domain, or both.

Aspect 9: The method of aspect 8, further comprising: adding the runtime provider to a registry of one or more runtime providers maintained at the runtime broker based at least in part on receiving the registration message from the runtime provider.

Aspect 10: The method of aspect 9, further comprising: receiving, at the runtime broker from the application, a deregistration message indicating the provider domain and the address associated with the runtime provider; and removing the runtime provider from the registry of the one or more runtime providers based at least in part on receiving the deregistration message.

Aspect 11: The method of any of aspects 9 through 10, further comprising: removing the runtime provider from the registry of the one or more runtime providers based at least in part on determining that the regular interval has elapsed without receiving the indication of the active status of the runtime provider.

Aspect 12: The method of any of aspects 8 through 11, further comprising: receiving, from the application, a third request to delete the agent actor, wherein the second request indicates the provider domain and the identifier associated with the agent actor; and transmitting, to the runtime provider, the third request to delete the agent actor based at least in part on the provider domain and the identifier associated with the agent actor.

Aspect 13: An apparatus for data processing, comprising one or more memories storing processor-executable code, and one or more processors coupled with the one or more memories and individually or collectively operable to execute the code to cause the apparatus to perform a method of any of aspects 1 through 7.

Aspect 14: An apparatus for data processing, comprising at least one means for performing a method of any of aspects 1 through 7.

Aspect 15: A non-transitory computer-readable medium storing code for data processing, the code comprising instructions executable by one or more processors to perform a method of any of aspects 1 through 7.

Aspect 16: An apparatus for data processing, comprising one or more memories storing processor-executable code, and one or more processors coupled with the one or more memories and individually or collectively operable to execute the code to cause the apparatus to perform a method of any of aspects 8 through 12.

Aspect 17: An apparatus for data processing, comprising at least one means for performing a method of any of aspects 8 through 12.

Aspect 18: A non-transitory computer-readable medium storing code for data processing, the code comprising instructions executable by one or more processors to perform a method of any of aspects 8 through 12.

It should be noted that the methods described above describe possible implementations, and that the operations and the steps may be rearranged or otherwise modified and that other implementations are possible. Furthermore, aspects from two or more of the methods may be combined.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable ROM (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method for data processing, comprising:
transmitting, from a runtime provider to a runtime broker, a registration message indicating a provider domain associated with the runtime provider and an address associated with the runtime provider;
transmitting, at a regular interval to the runtime broker, an indication of an active status of the runtime provider based at least in part on transmitting the registration message;
receiving, from the runtime broker based at least in part on the indication of the active status, a request to spawn an agent actor assigned to a task based at least in part on the provider domain, the request indicating an identifier associated with the agent actor;
spawning the agent actor in response to the request;
receiving, from the runtime broker based at least in part on the indication of the active status, a message indicating the identifier associated with the agent actor and context information associated with the task assigned to the agent actor;
routing the message to the agent actor associated with the identifier based at least in part on receiving the message; and
managing computational resources for the agent actor based at least in part on spawning the agent actor and routing the message to the agent actor.

2. The method of claim 1, further comprising:
associating the agent actor with a corresponding thread of one or more processing devices of the runtime provider.

3. The method of claim 1, wherein routing the message to the agent actor associated with the identifier comprises:
routing, via a guardian actor of the runtime provider, the message from an application programming interface of the runtime provider to the agent actor.

4. The method of claim 1, wherein:
spawning the agent actor comprises storing a behavioral state associated with the agent actor and the identifier in a first table, wherein one or more actor executors managed by the runtime provider are capable of accessing and updating the behavioral state in the first table based at least in part on one or more messages received at the runtime provider; and
receiving the message indicating the identifier associated with the agent actor comprises storing the message and the identifier in a second table accessible to the one or more actor executors.

5. The method of claim 4, wherein routing the message to the agent actor associated with the identifier comprises:
storing the identifier associated with the agent actor in a queue accessible to the one or more actor executors at the runtime provider, wherein the stored identifier comprises a trigger for an actor executor of the one or more actor executors to perform one or more actions in response to the message stored in the second table and according to the behavioral state stored in the first table based at least in part on the identifier.

6. The method of claim 5, further comprising:
maintaining a database of one or more locks corresponding to the one or more actor executors, wherein a lock of the one or more locks indicates whether a second actor executor of the one or more actor executors is currently retrieving the message from the second table, retrieving the behavioral state, or performing the one or more actions based at least in part on the stored identifier.

7. The method of claim 5, further comprising:
updating the behavioral state of the agent actor in the first table in response to the actor executor performing the one or more actions in response to the message.

8. A method for data processing, comprising:
receiving, at a runtime broker from a runtime provider, a registration message indicating a provider domain and an address associated with the runtime provider;
receiving, at a regular interval from the runtime provider, an indication of an active status of the runtime provider based at least in part on receiving the registration message;
receiving, from an application, a first request to spawn an agent actor, wherein the first request indicates the provider domain and an identifier associated with the agent actor;
transmitting, to the runtime provider in response to receiving the first request, a second request to spawn the agent actor based at least in part on the provider domain, the second request indicating the identifier associated with the agent actor;
receiving a message indicating the provider domain, the identifier associated with the agent actor, and context information associated with a task assigned to the agent actor; and
routing the message to the runtime provider based at least in part on the identifier associated with the agent actor, the provider domain, or both.

9. The method of claim 8, further comprising:
adding the runtime provider to a registry of one or more runtime providers maintained at the runtime broker based at least in part on receiving the registration message from the runtime provider.

10. The method of claim 9, further comprising:
receiving, at the runtime broker from the application, a deregistration message indicating the provider domain and the address associated with the runtime provider; and
removing the runtime provider from the registry of the one or more runtime providers based at least in part on receiving the deregistration message.

11. The method of claim 9, further comprising:
removing the runtime provider from the registry of the one or more runtime providers based at least in part on determining that the regular interval has elapsed without receiving the indication of the active status of the runtime provider.

12. The method of claim 8, further comprising:
receiving, from the application, a third request to delete the agent actor, wherein the second request indicates the provider domain and the identifier associated with the agent actor; and
transmitting, to the runtime provider, the third request to delete the agent actor based at least in part on the provider domain and the identifier associated with the agent actor.

13. A system for data processing, comprising:
a runtime broker configured to:
receive, from a runtime provider, a registration message indicating a provider domain and an address associated with the runtime provider;
receive, from an application, a first request to spawn an agent actor, wherein the first request indicates the provider domain and an identifier associated with the agent actor; and
transmit, to the runtime provider, a second request to spawn the agent actor based at least in part on the provider domain, the second request indicating the identifier associated with the agent actor; and
the runtime provider configured to:
spawn the agent actor in response to receiving the second request;
receive, from the runtime broker, a message indicating the identifier associated with the agent actor, the message further indicating context information associated with a task assigned to the agent actor;
route the message to the agent actor based at least in part on the message indicating the identifier; and
manage computational resources for the agent actor based at least in part on spawning the agent actor and routing the message to the agent actor.

14. The system of claim 13, wherein the runtime broker is further configured to:
add the runtime provider to a registry of one or more runtime providers maintained at the runtime broker based at least in part on receiving the registration message from the runtime provider.

15. The system of claim 14, further comprising:
receiving, at the runtime broker from the application, a deregistration message indicating the provider domain and the address associated with the runtime provider; and
removing the runtime provider from the registry of the one or more runtime providers based at least in part on receiving the deregistration message.

16. The system of claim 14, wherein the runtime broker is further configured to:
remove the runtime provider from the registry of the one or more runtime providers based at least in part on determining that a regular interval has elapsed without receiving an indication of an active status of the runtime provider.

17. The system of claim 13, wherein the runtime provider is further configured to:
associate the agent actor with a corresponding thread of one or more processing devices of the runtime provider.

18. The system of claim 13, wherein:
to spawn the agent actor, the runtime provider is configured to store a behavioral state associated with the agent actor and the identifier in a first table, wherein one or more actor executors managed by the runtime provider are capable of accessing and updating the behavioral state in the first table based at least in part on one or more messages received at the runtime provider; and
to receive the message indicating the identifier associated with the agent actor, the runtime provider is configured to store the message and the identifier in a second table accessible to the one or more actor executors.

19. The system of claim 18, wherein, to route the message to the agent actor associated with the identifier, the runtime provider is configured to:
store the identifier associated with the agent actor in a queue accessible to the one or more actor executors at the runtime provider, wherein the stored identifier comprises a trigger for an actor executor of the one or more actor executors to perform one or more actions in response to the message stored in the second table and according to the behavioral state in the first table based at least in part on the identifier.

20. The system of claim 19, wherein the runtime provider is further configured to:
maintain a database of one or more locks corresponding to the one or more actor executors, wherein a lock of the one or more locks indicates whether a second actor executor of the one or more actor executors is currently retrieving the message from the second table, retrieving the behavioral state, or performing the one or more actions based at least in part on the stored identifier.
